(19) United States
(12) Patent Application Publication
(10) Pub. No.: US 2011/0024205 A1
(43) Pub. Date: Feb. 3, 2011

(54) BATTERY MODULE, BATTERY SYSTEM AND ELECTRIC VEHICLE

(75) Inventors: Yoshitomo NISHIHARA, Osaka-City (JP); Kazumi OHKURA, Nara-City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi-City (JP)

(21) Appl. No.: 12/845,405

(22) Filed: Jul. 28, 2010

(30) Foreign Application Priority Data
Jul. 29, 2009 (JP) 2009-176903
Jul. 23, 2010 (JP) 2010-166095

(51) Int. Cl. B60K 1/00; H01M 2/26

(52) U.S. Cl. 180/65.1; 429/90

(57) ABSTRACT

A long-sized FPC board extending in an X-direction is connected in common to a plurality of bus bars on the side of one ends of a plurality of battery cells. Similarly, a long-sized FPC board extending in the X-direction is connected in common to a plurality of bus bars on the side of the other ends in a Y-direction of the plurality of battery cells. Each FPC board has a configuration in which a plurality of conductor lines are formed on an insulating layer, and has bending characteristics and flexibility. Each FPC board is arranged on the plurality of battery cells while being bent double.

### BACKGROUND OF THE INVENTION

1. Field of the Invention

The present invention relates to a battery module, and a battery system and an electric vehicle including the same.

2. Description of the Background Art

Conventionally in movable objects such as electric automobiles using electric power as driving sources, battery modules including a plurality of battery cells connected in series or in parallel have been used.

In order to recognize the residual capacity (charged capacity) of the battery module or prevent overcharge and overdischarge of the battery module, a terminal voltage of the battery module is to be detected. Therefore, a detecting circuit for detecting the terminal voltage of the battery module is connected to the battery module (see, e.g., JP 8-162171 A).

In the electric automobiles, the detecting circuit is generally connected to the battery module through leads composed of a metal wire, for example. However, if external stress due to vibrations or the like is continuously applied to the leads, the leads may be broken, resulting in shorts between the detecting circuit and the battery module in some cases.

### BRIEF SUMMARY OF THE INVENTION

An object of the present invention is to provide a battery module in which a short is sufficiently prevented from occurring, and a battery system and an electric vehicle including the same.

(1) According to one aspect of the present invention, a battery module includes a plurality of battery cells, an insulating substrate having first and second regions arranged along the plurality of battery cells, and a plurality of lines formed in the insulating substrate, wherein the plurality of lines include a plurality of voltage detection lines electrically connected to the plurality of battery cells, respectively, for detecting terminal voltages of the plurality of battery cells, and the first and second regions of the insulating substrate are arranged on different planes.

In the battery module, the plurality of lines including the plurality of voltage detection lines are formed in the insulating substrate that has the first and second regions arranged along the plurality of battery cells. The terminal voltages of the plurality of battery cells are detected by means of the plurality of voltage detection lines. In this case, the plurality of lines are formed in the insulating substrate, thereby preventing the plurality of lines from being disconnected. This sufficiently prevents occurrence of shorts in the lines.

The first and second regions of the insulating substrate are arranged on the different planes. This allows for a smaller area occupied by the insulating substrate without reducing the areas of the first and second regions. In this case, since the width and pitch of each of the plurality of lines need not be reduced, shorts and abnormal heat generation in the lines can be sufficiently prevented.

(2) The plurality of battery cells may be arranged to line up in one direction, the insulating substrate may include a common substrate having the first region and the second region with a boundary line extending in the one direction interposed between the first region and the second region, and the common substrate may be bent along the boundary line.

In this case, the common substrate having the first region and the second region are bent along the boundary line, thereby allowing for a smaller area occupied by the insulating substrate without reducing the areas of the first and second regions. Since the width and pitch of each of the plurality of lines need not be reduced, shorts and abnormal heat generation in the lines can be sufficiently prevented.

(3) One side portion of the first region may extend in the one direction along the plurality of battery cells, the plurality of voltage detection lines may be provided to extend from the one side portion of the first region to one end portion of the common substrate, and the second region may have a smaller length in the one direction than the first region, and arranged on a side of the one end portion of the common substrate so as to be along the first region.

In this case, since the plurality of voltage detection lines extend from the one side portion of the first region to the one end portion of the common substrate, the number of the voltage detection lines is increased in a region close to the one end portion of the common substrate.

Therefore, the second region having the smaller length in the one direction than the first region is provided along the first region on the side of the one end portion of the common substrate. In this case, the area of the common substrate on the side of the other end portion becomes smaller than the area of the common substrate on the side of the one end portion. This reduces useless space on the side of the other end portion of the common substrate. This results in lower material cost for the common substrate.

(4) The plurality of lines may include a plurality of first lines that extend parallel to one another along the boundary line in the first region, and a plurality of second lines that extend parallel to one another along the boundary line in the second region, and a distance between a first line that is the closest to the boundary line among the plurality of first lines and a second line that is the closest to the boundary line among the plurality of second lines may be larger than a distance between the plurality of first lines, and may be larger than a distance between the plurality of second lines.

In this case, since the common substrate can be easily bent such that the first and second lines do not overlap the boundary line, distortion is prevented from occurring in the first and second lines. This prevents the first and second lines from being damaged.

(5) Each of the plurality of battery cells may have a pair of electrode terminals that line up in a direction intersecting with the one direction, and include in a portion between the pair of electrode terminals a gas discharge portion for discharging gas in the battery cell when internal pressure of the battery cell rises, the insulating substrate may be arranged to pass through at least one of a portion between the gas discharge portion and one electrode terminal of each battery cell and a portion between the gas discharge portion and the other electrode terminal of each battery cell, and each voltage detection line may be connected to the one electrode terminal or the other electrode terminal of each battery cell.

In this case, the gas in the battery cell is discharged through the gas discharge portion when the internal pressure of each battery cell rises, thus preventing excessive rise in the internal pressure. The bent insulating substrate is arranged to pass through the at least one of the portion between the gas discharge portions and the one electrode terminals of the battery cells and the portion between the gas discharge portions and the other electrode terminals of the battery cells. This prevents the insulating substrate from overlapping the gas discharge portions. Thus, the insulating substrate does not inhibit discharge of the gas through the gas discharge portion. Accordingly, the gas in the battery cell is reliably discharged when the internal pressure rises. In addition, the insulating substrate is prevented from being damaged because of discharge of the gas.

(6) The insulating substrate may include a first substrate having the first region and a second substrate having the second region, and the first substrate and the second substrate may be arranged to overlap each other.

In this case, the first substrate having the first region and the second substrate having the second region are arranged to overlap each other. This allows for a smaller area occupied by the insulating substrate without reducing the areas of the first and second regions. In addition, since the width and pitch of each of the plurality of lines need not be reduced, shorts and abnormal heat generation in the lines can be sufficiently prevented.

(7) According to another aspect of the present invention, a battery system includes a plurality of battery modules each including a plurality of battery cells, a voltage detector that is used in common for the plurality of battery modules and detects terminal voltages of the battery cells, an insulating substrate provided along the plurality of battery cells of the plurality of battery modules and connected to the voltage detector, and a plurality of voltage detection lines formed in the insulating substrate, and electrically connected to the plurality of battery cells, respectively, of the plurality of battery modules and to the voltage detector for detecting the terminal voltages of the plurality of battery cells of the plurality of battery modules, wherein the insulating substrate includes a first region extending along the plurality of battery cells of the plurality of battery modules, and a second region extending along at least part of the plurality of battery cells of the plurality of battery modules, and the first and second regions of the insulating substrate are arranged on different planes.

In the battery system, the insulating substrate is provided along the plurality of battery cells of the plurality of battery modules. The plurality of voltage detection tines are formed in the insulating substrate. The insulating substrate is connected to the voltage detector. The terminal voltages of the plurality of battery cells of the plurality of battery modules are detected by the voltage detector. In this case, the plurality of voltage detection lines are formed in the insulating substrate, so that the plurality of voltage detection lines are prevented from being disconnected. This sufficiently prevents a short from occurring in the voltage detection lines. Since the voltage detector is used in common for the plurality of battery modules, the complicated configuration and increased cost of the battery system is suppressed.

The first region of the insulating substrate extends along the plurality of battery cells of the plurality of battery modules, and the second region of the insulating substrate extends along the at least part of the plurality of battery cells of the plurality of battery modules. The first and second regions are arranged on the different planes. This allows for a smaller area occupied by the insulating substrate without reducing the areas of the first and second regions. Since the width and pitch of each of the plurality of voltage detection lines need not be reduced, a short and abnormal heat generation in the voltage detection lines can be sufficiently prevented.

(8) According to still another aspect of the present invention, an electric vehicle includes a battery module according to the one aspect of the present invention, a motor driven by electric power supplied from the battery module, and a drive wheel rotated by a torque generated by the motor.

In the electric vehicle, the motor is driven by electric power supplied from the battery module. The torque generated by the motor causes the drive wheel to rotate, so that the electric vehicle moves.

In the battery module, the plurality of lines including the plurality of voltage detection lines are formed in the insulating substrate that has the first and second regions extending along the plurality of battery cells. The terminal voltages of the plurality of battery cells are detected by means of the plurality of voltage detection lines. In this case, the plurality of lines are formed in the insulating substrate, thereby preventing the lines from being disconnected. This sufficiently prevents shorts from occurring in the lines.

The first and second regions of the insulating substrate are arranged on the different planes. This allows for a smaller area occupied by the insulating substrate without reducing the areas of the first and second regions. In this case, since the width and pitch of each of the plurality of lines need not be reduced, shorts and abnormal heat generation in the lines can be sufficiently prevented.

Thus, the electric power supplied from the battery module to the motor can be increased, so that driving performance of the electric vehicle can be improved.

(9) According to still another aspect of the present invention, an electric vehicle includes a battery system according to the other aspect of the present invention, a motor driven by electric power supplied from the plurality of battery modules of the battery system, and a drive wheel rotated by a torque generated by the motor.

In the electric vehicle, the motor is driven by electric power supplied from the plurality of battery modules of the battery system. The torque generated by the motor causes the drive wheel to rotate, so that the electric vehicle moves.

In the battery system, the insulating substrate is provided along the plurality of battery cells of the plurality of battery modules. The plurality of voltage detection lines are formed in the insulating substrate. The insulating substrate is connected to the voltage detector. The terminal voltages of the plurality of battery cells of the plurality of battery modules are detected by the voltage detector. In this case, the plurality of voltage detection lines are formed in the insulating substrate, so that the plurality of voltage detection lines are prevented from being disconnected. This sufficiently prevents a short from occurring in the voltage detection lines. Since the voltage detector is used in common for the plurality of battery modules, the complicated configuration and increased cost of the battery system is suppressed.

The first region of the insulating substrate extends along the plurality of battery cells of the plurality of battery modules, and the second region of the insulating substrate extends along the at least part of the plurality of battery cells of the plurality of battery modules. The first and second regions are arranged on the different planes. This allows for a smaller area occupied by the insulating substrate without reducing the areas of the first and second regions. Since the width and pitch of each of the plurality of voltage detection lines need not be reduced, a short and abnormal heat generation in the voltage detection lines can be sufficiently prevented.

Thus, the electric power supplied from the plurality of battery modules to the motor is increased, so that driving performance of the electric vehicle can be improved.

According to the present invention, the plurality of lines are formed in the insulating substrate, thereby preventing the plurality of lines from being disconnected. This sufficiently prevents shorts from occurring in the lines. Moreover, the first and second regions of the insulating substrate are arranged on the different planes. This allows for a smaller area occupied by the insulating substrate without reducing the areas of the first and second regions.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWINGS

FIG. 1 is a block diagram illustrating the configuration of a battery system according to a first embodiment;

FIG. 2 is an external perspective view of a battery module;

FIG. 3 is a plan view of the battery module;

FIG. 4 is a side view of the battery module;

FIG. 5 is an external perspective view of the battery module having covers mounted thereon;

FIG. 6 is an external perspective view of bus bars;

FIG. 7 is an external perspective view for explaining the configuration of an FPC board;

FIG. 8 is a schematic plan view for explaining connection between the bus bars and a detecting circuit;

FIG. 9 is a schematic side view showing an example of bending of the FPC board;

FIG. 10 is an external perspective view of the battery module to which the FPC board of FIG. 9 (e) is attached;

FIG. 11 is a schematic plan view of another FPC board;

FIG. 12 is a diagram showing one example of a method of forming the another FPC board;

FIG. 13 is a schematic plan view of another FPC board;

FIG. 14 is a schematic plan view of still another FPC board;

FIG. 15 is a schematic plan view of yet another FPC board;

FIG. 16 shows a schematic plan view and a schematic side view of an FPC board in which a connection terminal for connecting a thermistor is provided;

FIG. 17 shows a schematic plan view and a schematic side view of an FPC board in which the connection terminal for connecting the thermistor is provided;

FIG. 18 shows a schematic plan view of an FPC board in which the connection terminal for connecting the thermistor is provided;

FIG. 19 is a schematic plan view of another FPC board;

FIG. 20 shows a schematic plan view and a schematic side view of another FPC board;

FIG. 21 shows a schematic plan view and a schematic side view illustrating another example of the arrangement of a PTC element;

FIG. 22 shows a schematic plan view and a schematic side view illustrating still another example of the arrangement of the PTC element;

FIG. 23 is a schematic plan view showing a modification of the bus bars;

FIG. 24 is an external perspective view showing another example of the battery module;

FIG. 25 is a diagram showing an example of configuration in which two battery modules are connected to each other;

FIG. 26 is a diagram showing another example of the configuration in which the two battery modules are connected to each other;

FIG. 27 shows a schematic plan view and a schematic side view showing another example of the configuration in which the two battery modules are connected to each other;

FIG. 28 is a schematic plan view showing a specific example of arrangement of the battery system;

FIG. 29 is a schematic plan view showing another example of connection of communication lines in the battery system of FIG. 28;

FIG. 30 is a block diagram showing the configuration of an electric automobile according to a second embodiment.

### DETAILED DESCRIPTION OF THE INVENTION

### [1] First Embodiment

A battery module according to a first embodiment and a battery system including the same will be described below with reference to the drawings. The battery module and the battery system according to the present embodiment are carried on an electric vehicle (e.g., an electric automobile) using electric power as a driving source.

### (1) Configuration of Battery System

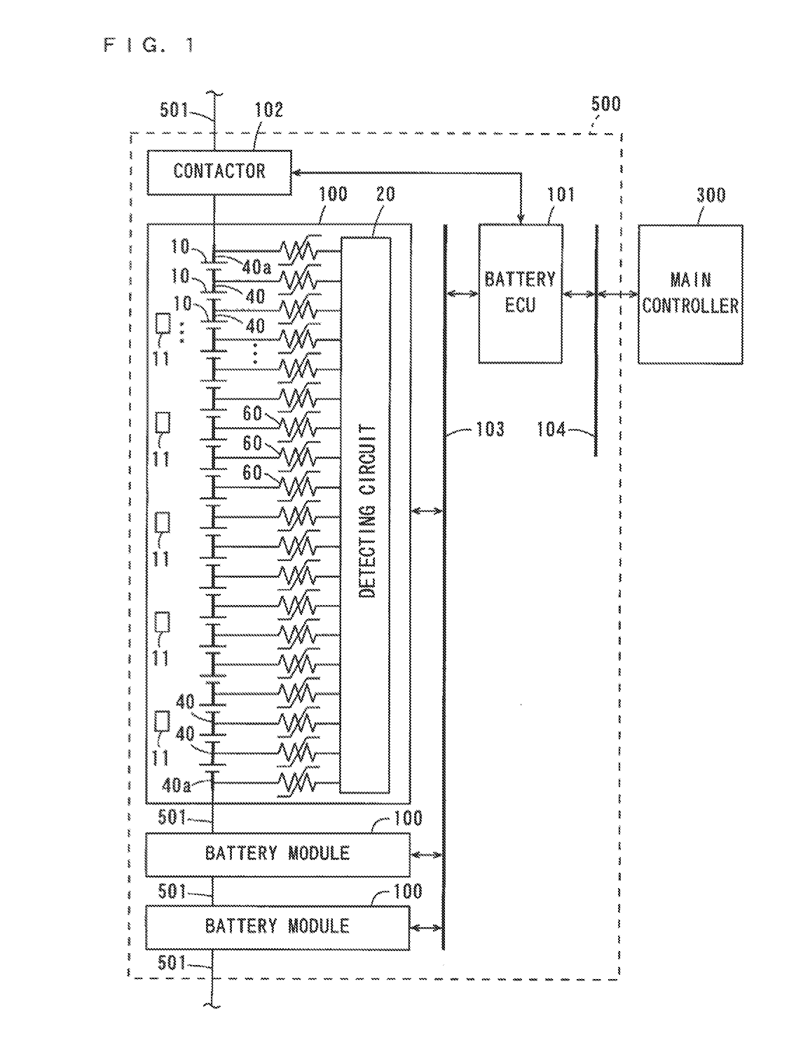

FIG. 1 is a block diagram illustrating the configuration of a battery system according to a first embodiment. As illustrated in FIG. 1, a battery system 500 includes a plurality of battery modules 100, a battery electronic control unit (ECU) 101, and a contactor 102, and is connected to a main controller 300 in an electric vehicle via a bus 104.

The battery modules 100 in the battery system 500 are connected to one another via a power supply line 501. Each of the battery modules 100 includes a plurality of (eighteen in this example) battery cells 10, a plurality of (five in this example) thermistors 11, and a detecting circuit 20.

In each of the battery modules 100, the battery cells 10 are integrally arranged to be adjacent to one another, and are connected in series by a plurality of bus bars 40. Each of the battery cells 10 is a secondary battery such as a lithium ion battery or a nickel hydrogen battery.

The battery cells 10 arranged at both ends of the battery module 100 are connected to the power supply line 501, respectively, via the bus bars 40a. Thus, in the battery system 500, all the battery cells 10 in the plurality of battery modules 100 are connected in series. The power supply line 501 pulled out of the battery system 500 is connected to a load such as a motor in the electric vehicle. Details of the battery module 100 will be described below.

The detecting circuit 20 is electrically connected to each of the bus bars 40, 40a via a positive temperature coefficient (PTC) element 60. The detecting circuit 20 is electrically connected to each of the thermistors 11. The detecting circuit 20 detects a terminal voltage of each of the battery cells 10 and its temperature and a current flowing through each of the bus bars 40, 40a.

The detecting circuit 20 in each of the battery modules 100 is connected to the battery ECU 101 via a bus 103. Thus, the voltage, the current, and the temperature that are detected by the detecting circuit 20 are given to the battery ECU 101.

The battery ECU 101 calculates the charged capacity of each of the battery cells 10 based on the voltage, the current, and the temperature that are given from the detecting circuit 20 in each of the battery modules 100, for example, and carries out charge/discharge control of the battery module 100 based on the charged capacity. The battery ECU 101 detects an abnormality in each of the battery modules 100 based on the voltage, the current, and the temperature that are given from the detecting circuit 20 in the battery module 100. The abnormality in the battery module 100 includes overdischarge, overcharge, and a temperature abnormality of the battery cell 10, for example.

The contactor 102 is inserted in the power supply line 501 connected to the battery module 100 at one end of the battery system 500. The battery ECU 101 turns the contactor 102 off when it detects the abnormality in the battery module 100. Thus, no current flows through each of the battery modules 100 when the abnormality occurs. This prevents the battery module 100 from generating abnormal heat.

The battery ECU 101 is connected to the main controller 300 via the bus 104. The charged capacity of each of the battery modules 100 (the charged capacity of the battery cells 10) is given to the main controller 300 from the battery ECU 101. The main controller 300 controls the power of the electric vehicle (e.g., the rotational speed of the motor in the electric vehicle) based on the charged capacity. When the charged capacity of each of the battery modules 100 is reduced, the main controller 300 controls a power generation device (not illustrated) connected to the power supply line 501, to charge the battery module 100.

### (2) Details of Battery Module

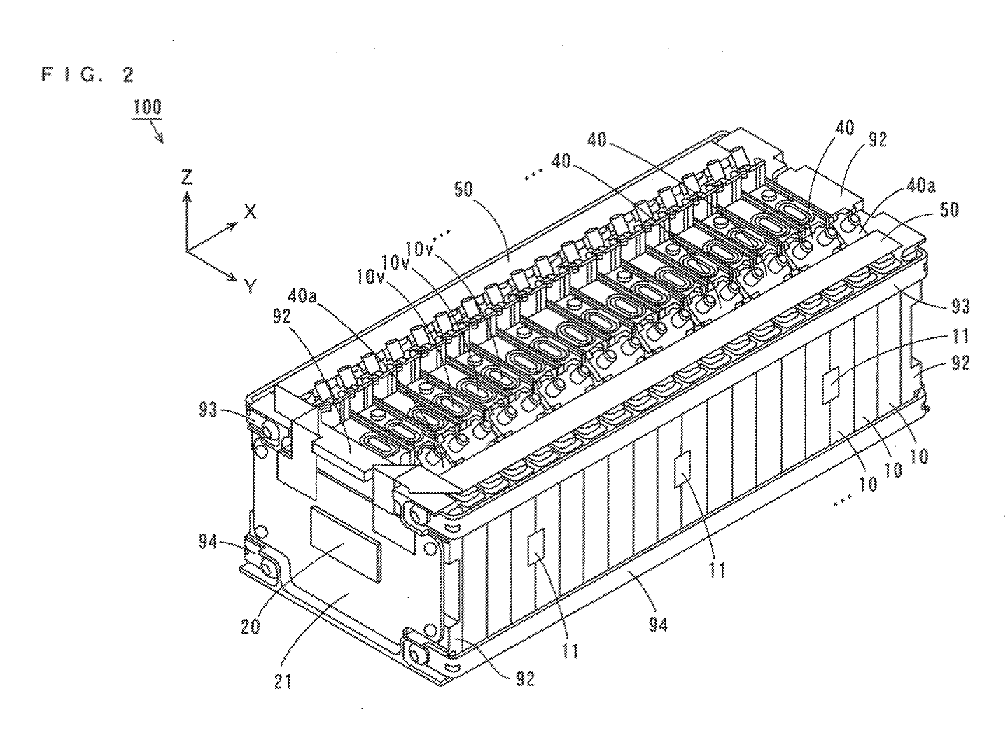

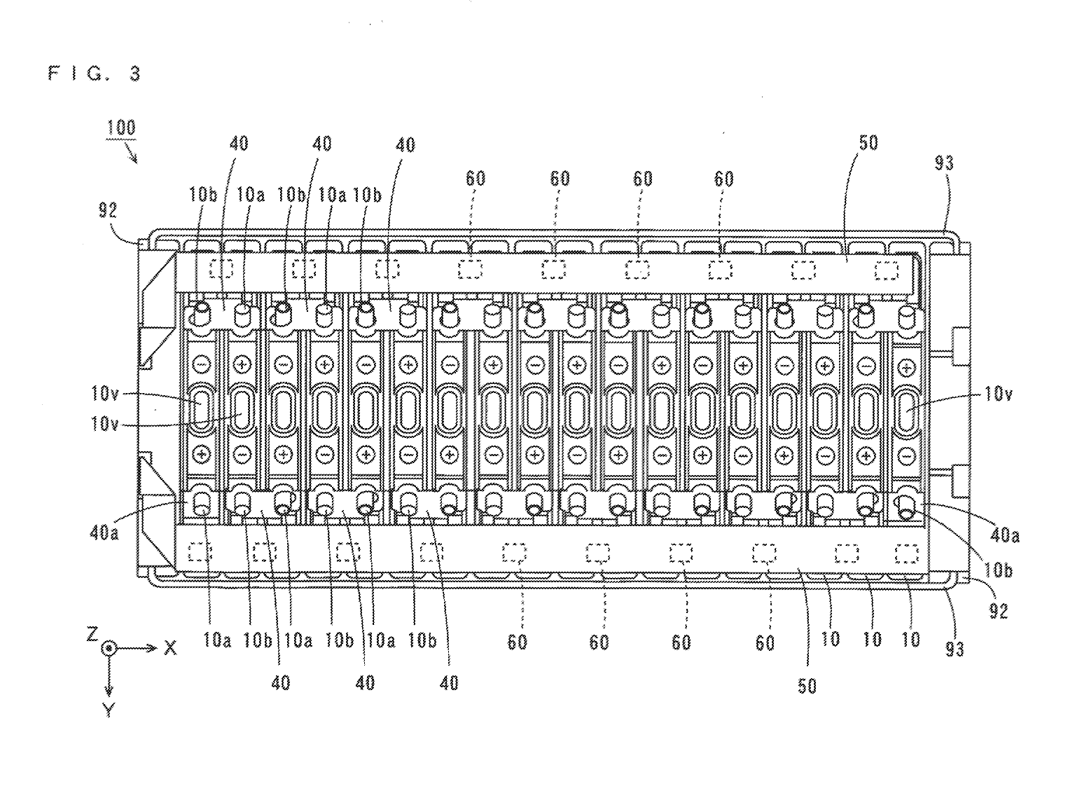

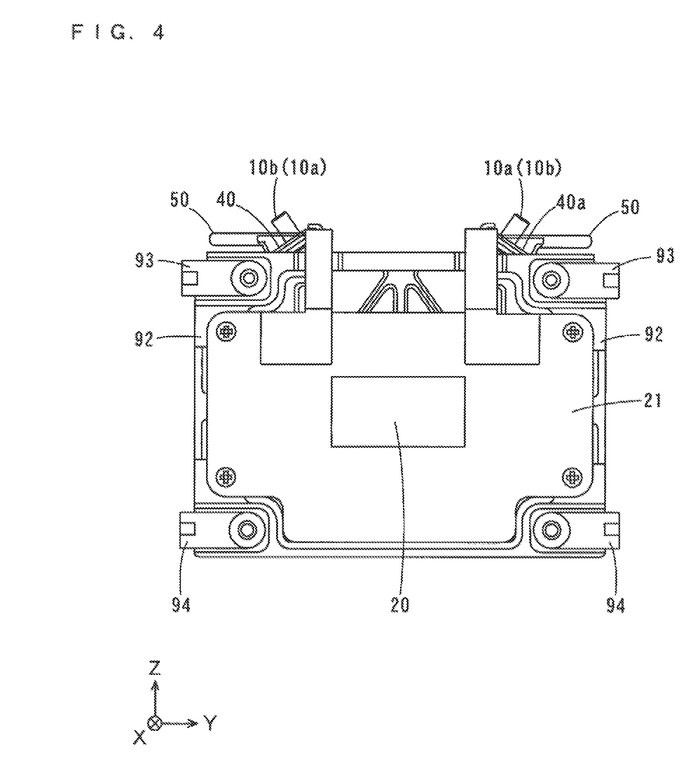

The details of the battery module 100 will be described. FIG. 2 is an external perspective view of the battery module 100, FIG. 3 is a plan view of the battery module 100, and FIG. 4 is a side view of the battery module 100.

In FIGS. 2 to 4 and FIGS. 5 to 27, described below, three directions that are perpendicular to one another are respectively defined as an X-direction, a Y-direction, and a 2-direction, as indicated by arrows X, Y, and 2. In this example, the X-direction and the Y-direction are directions parallel to a horizontal plane, and the Z-direction is a direction perpendicular to the horizontal plane.

As illustrated in FIGS. 2 to 4, in the battery module 100, the plurality of battery cells 10 having a flat and substantially rectangular parallelepiped shape are arranged to line up in the X-direction. In this state, the battery cells 10 are integrally fixed by a pair of end surface frames 92, a pair of upper end frames 93, and a pair of lower end frames 94.

The pair of end surface frames 92 has a substantially plate shape, and is arranged parallel to a Y-Z plane. The pair of upper end frames 93 and the pair of lower end frames 94 are arranged to extend in the X-direction.

Connection portions for connecting the pair of upper end frames 93 and the pair of lower end frames 94 are respectively formed at four corners of the pair of end surface frames 92. With the plurality of battery cells 10 arranged between the end surface frames 92, the pair of upper end frames 93 is attached to the connection portions at the upper corners of the pair of end surface frames 92, and the pair of lower end frames 94 is attached to the connection portions at the lower corners of the pair of end surface frames 92. Thus, the battery cells 10 are integrally fixed to line up in the X-direction.

A rigid printed circuit board (hereinafter abbreviated as a printed circuit board) 21 is attached to an outer surface of one of the end surface frames 92 with a predetermined distance therebetween. The detecting circuit 20 is provided on the printed circuit board 21.

Here, the plurality of battery cells 10 each have a plus electrode 10a arranged on an upper surface portion on one end side or the other end side in the Y-direction, and have a minus electrode 10b arranged on an upper surface portion on the opposite side. Each of the electrodes 10a, 10b is provided to be inclined and project upward (see FIG. 4).

Each of the battery cells 10 has a gas vent valve 10v at the center of its upper surface. When internal pressure of the battery cell 10 rises to a given value, gas in the battery cell 10 is discharged through the gas vent valve 10v. This prevents excessive rise in the internal pressure of the battery cell 10.

In the following description, the battery cell 10 adjacent to the end surface frame 92 on which the printed circuit board 21 is not attached to the battery cell 10 adjacent to the end surface frame 92 on which the printed circuit board 21 is attached are referred to as first to eighteenth battery cells 10.

As illustrated in FIG. 3, in the battery module 100, the battery cells 10 are arranged so that the respective positional relationships between the plus electrodes 10a and the minus electrodes 10b in the Y-direction in the adjacent battery cells 10 are opposite to each other.

Thus, between the two adjacent battery cells 10, the plus electrode 10a and the minus electrode 10b of one of the battery cells 10 are respectively in close proximity to the minus electrode 10b and the plus electrode 10a of the other battery cell 10. In this state, the bus bar 40 is attached to the two electrodes in close proximity to each other. Thus, the battery cells 10 are connected in series.

More specifically, the common bus bar 40 is attached to the plus electrode 10a of the first battery cell 10 and the minus electrode 10b of the second battery cell 10. The common bus bar 40 is attached to the plus electrode 10a of the second battery cell 10 and the minus electrode 10b of the third battery cell 10. Similarly, the common bus bar 40 is attached to the plus electrode 10a of each of the odd-numbered battery cells 10 and the minus electrode 10b of each of the even-numbered battery cells 10. The common bus bar 40 is attached to the plus electrode 10a of each of the even-numbered battery cells 10 and the minus electrode 10b of each of the odd-numbered battery cells 10.

The bus bars 40a for externally connecting the power supply line 501 are respectively attached to the minus electrode 10b of the first battery cell 10 and the plus electrode 10a of the eighteenth battery cell 10.

A long flexible printed circuit board (hereinafter abbreviated as an FPC board) 50 extending in the X-direction is connected in common to the plurality of bus bars 40, 40a at respective one ends in the Y-direction of the plurality of battery cells 10. Similarly, a long FPC board 50 extending in the X-direction is connected in common to the plurality of bus bars 40 at the respective other ends in the Y-direction of the plurality of battery cells 10.

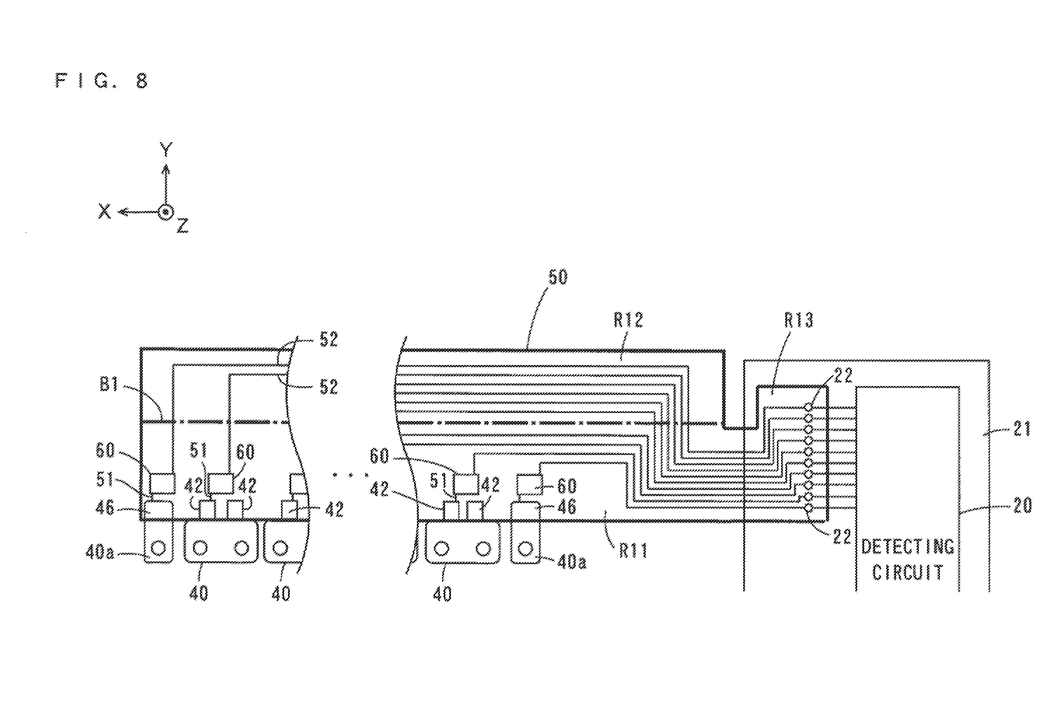

The FPC board 50 mainly has a configuration in which a plurality of conductor lines (wiring patterns) 51, 52 (see FIG. 8, described below) are formed on an insulating layer, and has bending characteristics and flexibility. Polyimide, for example, is used as a material for the insulating layer composing the FPC board 50, and copper, for example, is used as a material for the conductor lines 51, 52. Each of the FPC boards 50 is an example of an insulating substrate, and the conductor lines 51, 52 are examples of a voltage detection line.

Each FPC board 50 is arranged on the plurality of battery cells 10 while being bent double. The plurality of PTC elements 60 are attached to each FPC board 50. The PTC elements 60 are arranged in the vicinity of the bus bars 40, 40a, respectively. The details of the FPC boards 50 and the PTC elements 60 will be described below.

Each of the FPC boards 50 is bent at a right angle inward and further bent downward at an upper end portion of the end surface frame 92 (the end surface frame 92 on which the printed circuit board 21 is attached), and is connected to the printed circuit board 21.

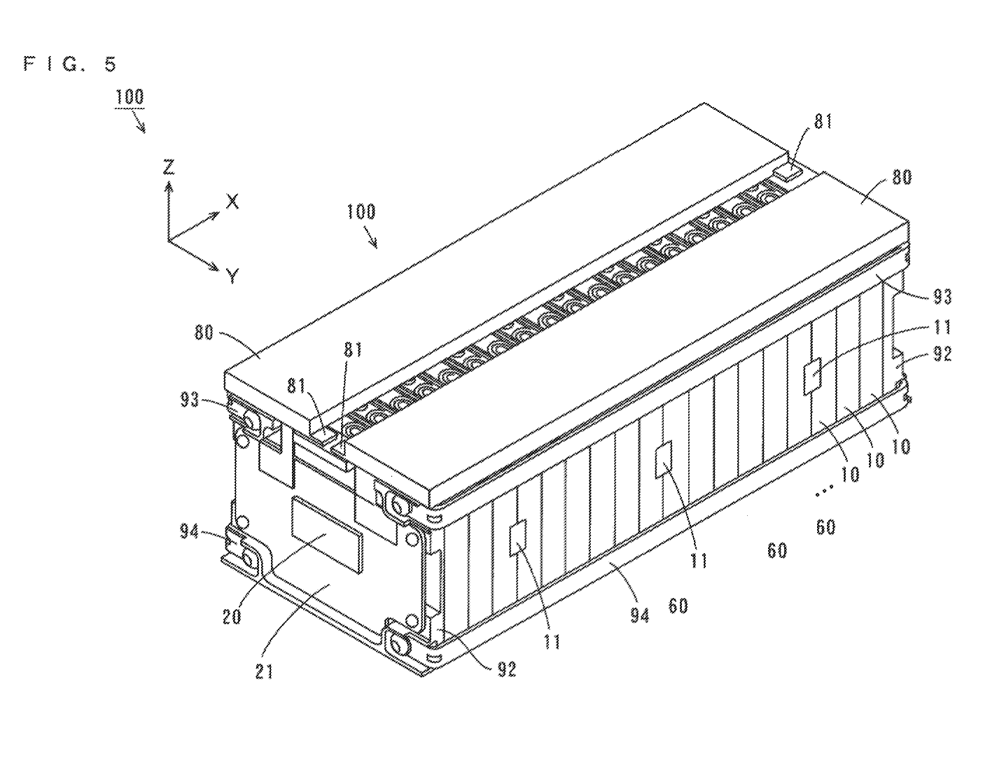

A pair of covers is mounted on the battery module 100 having the above-described configuration. FIG. 5 is an external perspective view of the battery module 100 having the covers mounted thereon.

As shown in FIG. 5, the pair of covers 80 each having a substantially rectangular shape extending in the X-direction is mounted on the battery module 100. The plurality of bus bars 40, 40a and the FPC board 50 arranged on the side of one side surface of the battery module 100 are covered with one cover 80, and the plurality of bus bars 40 and the FPC board 50 arranged on the side of the other side surface of the battery module 100 are covered with the other cover 80.

Pairs of attachment portions 81 are provided at respective ends of side surfaces, which face each other, of the pair of covers 80. The attachment portions 81 are fixed to the end surface frames 92 arranged at one end and the other end of the battery module 100, respectively, by screws or the like. Accordingly, the pair of covers 80 is fixed on the battery module 100.

### (3) Structures of Bus Bars and FPC Board

The details of the structures of the bus bars 40, 40a and the FPC board 50 will be then described. The bus bar 40 for connecting the plus electrode 10a and the minus electrode 10b of the adjacent battery cells 10 is hereinafter referred to as a bus bar 40 for two electrodes, and the bus bar 40a for connecting the plus electrode 10a or the minus electrode 10b of the one battery cell 10 and the power supply line 501 is referred to as a bus bar 40a for a single electrode.

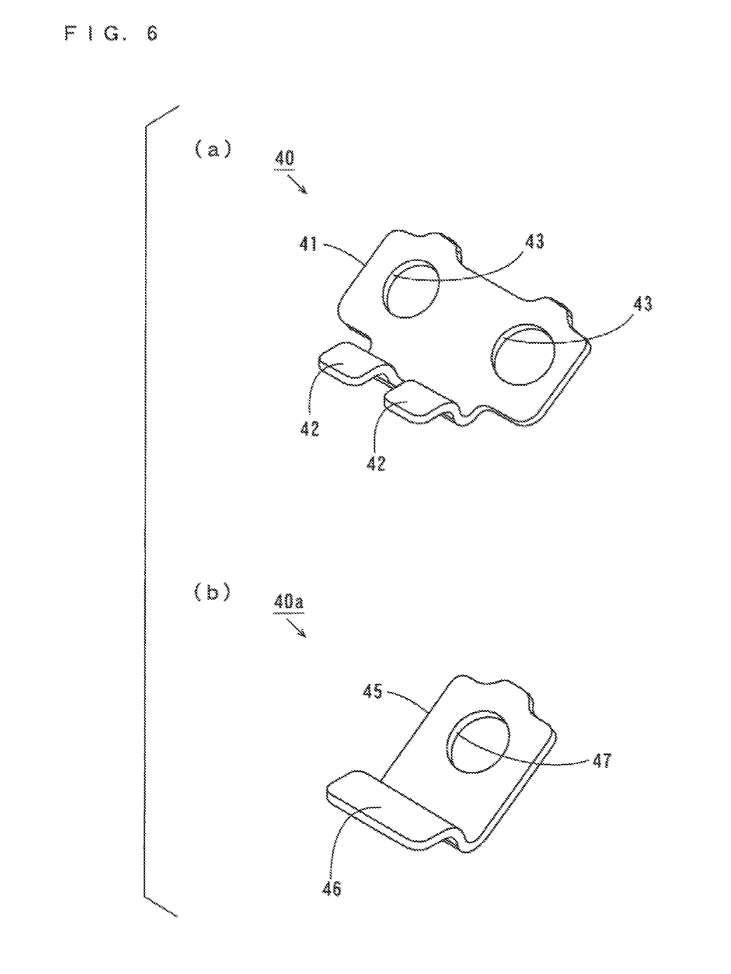

FIG. 6 (a) is an external perspective view of the bus bar 40 for two electrodes, and FIG. 6 (b) is an external perspective view of the bus bar 40a for a single electrode.

As illustrated in FIG. 6 (a), the bus bar 40 for two electrodes includes a base portion 41 having a substantially rectangular shape, and a pair of attachment portions 42 bent and extending toward one surface side from one side of the base portion 41. A pair of electrode connection holes 43 is formed in the base portion 41.

As illustrated in FIG. 8 (b), the bus bar 40a for a single electrode includes a base portion 45 having a substantially square shape, and an attachment portion 46 bent and extending toward one surface side from one side of the base portion 45. An electrode connection hole 47 is formed in the base portion 45.

In the present embodiment, the bus bars 40, 40a have a configuration in which a surface of tough pitch copper is nickel-plated, for example.

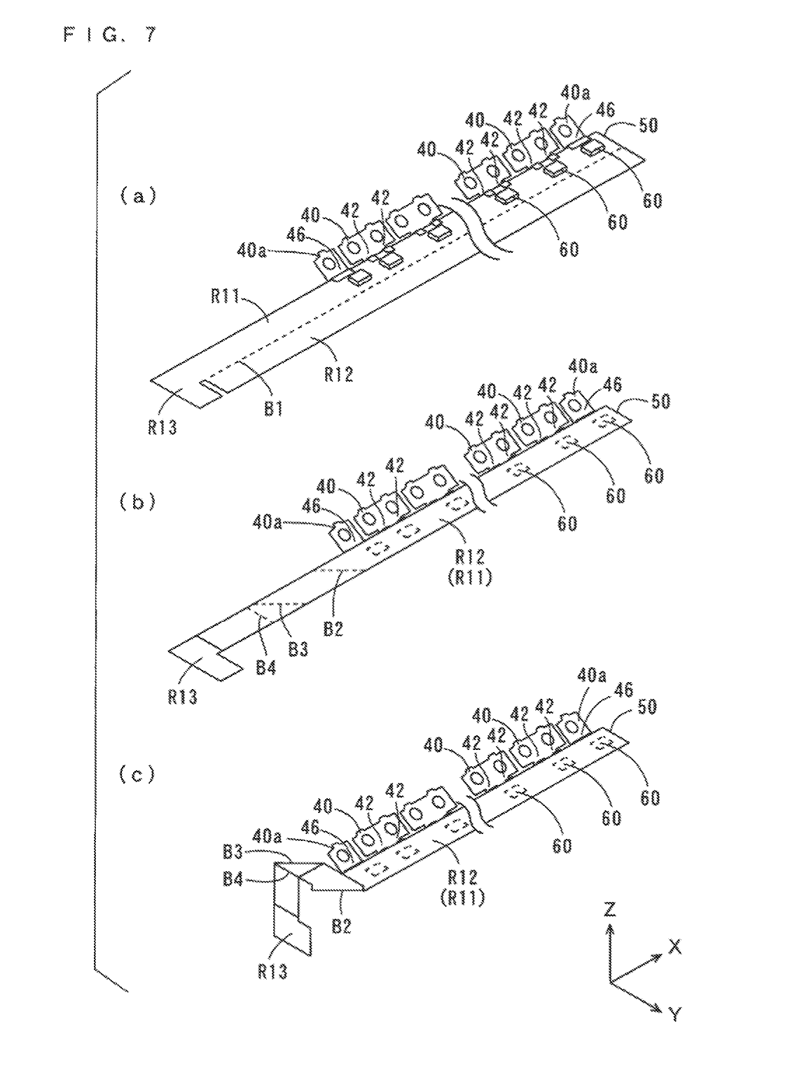

FIG. 7 is an external perspective view for explaining the configuration of the FPC board 50. FIG. 7 (a) shows the FPC board 50 that is not bent, and FIGS. 7 (b) and (c) show the FPC board 50 that is bent in steps.

FIG. 7 shows the FPC board 50 arranged on the side of the one side surface of the battery module 100. The configuration of the FPC board 50 arranged on the side of the other side surface of the battery module 100 and the bent states thereof are the same as those of the FPC board 50 shown in FIG. 7.

Hereinafter, an upper surface and a lower surface of the FPC board 50 that is not bent are referred to as a top surface and a back surface, respectively.

As shown in FIG. 7 (a), the FPC board 50 has a substantially rectangular shape, and has a first region R11, a second region R12 and a connection region R13. The first region R11 and the second region R12 extend parallel to each other in the X-direction with a bending line B1 parallel to the X-direction as the border. The connection region R13 is provided at one end of the first region R11.

The attachment portions 42, 46 of the plurality of bus bars 40, 40a are attached to the top surface of the first region R11 such that the plurality of bus bars 40, 40a line up at given spacings along a lateral side of the first region R11. The plurality of PTC elements 60 are attached to the top surface of the first region R11 at the same spacings as the spacings between the plurality of bus bars 40, 40a. In this state, the FPC board 50 is bent at the bending line B1.

The FPC board 50 is valley-folded at the bending line B1, so that the second region R12 overlaps the first region R11 as shown in FIG. 7 (b), This causes the plurality of PTC elements 60 to be covered with the second region R12.

The first region R11 is an example of a first region of the insulating substrate, the second region R12 is an example of a second region of the insulating substrate, and the bending line B1 is an example of a boundary line. The FPC board 50 is bent at the bending line B1, so that the first region R11 and the second region R12 are arranged on different planes.

Then, between the bus bar 40a at the one end and the connection region R13, the first region R11 and the second region R12 that overlap each other are valley-folded at a bending line B2 that forms an angle of 45 degrees with the Y-direction, while being mountain-folded at a bending line B3 parallel to the bending line B2, and further bent downward at an angle of 90 degrees at a bending line B4 parallel to the Y-direction.

With the FPC board 50 bent in the foregoing manner (in the state shown in FIG. 7 (c)), the plurality of bus bars 40, 40a are attached to the plurality of battery cells 10, respectively, and the connection region R13 of the FPC board 50 is connected to the printed circuit board 21 as illustrated in FIG. 2.

For mounting the plurality of bus bars 40, 40a on the plurality of battery cells 10, the plus electrode 10a and the minus electrode 10b of the adjacent battery cells 10 are fitted in the electrode connection holes 43, 47 formed in the bus bars 40, 40a, respectively. A male screw is formed in each of the plus electrode 10a and the minus electrode 10b. The male screws of the plus and the minus electrodes 10a, 10b are screwed into nuts (not illustrated), respectively, with the plus and minus electrodes 10a, 10b in the adjacent battery cells 10 fitted in the bus bars 40, 40a, respectively.

### (4) Connection Between Bus Bars And Detecting Circuit

Connection between the bus bars 40, 40a and the detecting circuit 20 will be then described. FIG. 8 is a schematic plan view for explaining connection between the bus bars 40, 40a and the detecting circuit 20. FIG. 8 shows the FPC board 50 that is not bent.

As illustrated in FIG. 8, the FPC board 50 is provided with the plurality of conductor lines 51, 52 that correspond to the bus bars 40, 40a, respectively. The conductor lines 51 are provided in the first region R11 to extend between the attachment portions 42, 46 in the bus bars 40, 40a and the PTC elements 60 arranged in the vicinity of the bus bars 40, 40a, and the conductor lines 52 are provided in the first region R11 and the second region R12 to extend from the PTC elements 60 to the connection region R13.

One end and the other end of each conductor line 51 and one end of each conductor line 52 are provided to be exposed on the top surface of the FPC board 50. The one ends of the conductor lines 51 exposed on the top surface are connected to the attachment portions 42, 46 in the bus bars 40, 408, respectively, by soldering or welding, for example.

A pair of terminals (not illustrated) of the PTC element 60 is connected to the other end of each of the conductor lines 51 and one end of each of the conductor lines 52 by soldering, for example.

Each of the PTC elements 60 is preferably arranged in a region between both ends in the X-direction of the corresponding bus bar 40, 40a. When stress is applied to the FPC board 50, a region of the FPC board 50 between the adjacent bus bars 40, 40a is easily deflected, while a region of the FPC board 50 between both the ends of each of the bus bars 40, 40a is kept relatively flat because it is fixed to the bus bar 40, 40a. Therefore, each of the PTC elements 60 is arranged within the region of the FPC board 50 between both the ends of each of the bus bars 40, 40a so that connection characteristics between the PTC element 60 and the conductor lines 51, 52 are sufficiently ensured. The effect of the deflection of the FPC board 50 on each of the PTC elements 60 (e.g., a change in the resistance value of the PTC element 60) is suppressed.

A plurality of connection terminals 22 corresponding to the conductor lines 52, respectively, in the FPC board 50 are provided in the printed circuit board 21. The other end of each of the conductor lines 52 in the FPC board 50 is connected to the corresponding connection terminal 22. The plurality of connection terminals 22 are electrically connected to the detecting circuit 20.

Here, the plurality of conductor lines 52 are provided to extend parallel to one another in the X-direction in the first region R11 and the second region R12 of the FPC board 50. In this case, as the position of the PTC element 60 is closer to the connection region R13, the conductor line 52 connected to the PTC element 60 is arranged closer to the inside (the side on which the bus bars 40, 40a are attached). That is, the plurality of conductor lines 52 are arranged closer to the inside in the order in which the corresponding PTC elements 60 are close to the connection region R13.

in the example of FIG. 8, the conductor line 52 connected to the closest PTC element 60 to the connection region R13 to the conductor line 52 connected to the fourth-closest PTC element 60 to the connection region R13 are arranged to extend parallel to one another in the X-direction in the first region R11.

The conductor line 52 connected to the fifth closest PTC element 60 to the connection region R13 to the conductor line 52 connected to the farthest PTC element 60 from the connection region R13 are arranged to extend parallel to one another in the X-direction in the second region R12.

Each conductor line 52 is arranged such that its portion extending in the X-direction does not overlap the bending line B1. Thus, each conductor lines 52 is prevented from being extensively distorted when the FPC board 50 is bent at the bending line B1. This prevents the conductor lines 52 from being damaged.

A distance between the conductor lines 52 adjacent to each other with the bending line B1 interposed therebetween is preferably larger than a distance between the conductor lines 52 adjacent to each other on the common region. In this case, the bending line B1 is more reliably prevented from overlapping the conductor line 52 when the FPC board 50 is bent.

### (5) Effects of the Embodiment

### (5-1) Effects of the FPC Board

In the present embodiment, each of the bus bars 40, 40a and the printed circuit board 21 are electrically connected to each other through the conductor lines 51, 52 formed on the FPC board 50. In this case, the FPC board 50 has bending characteristics and flexibility. Even if external stress is applied to the FPC board 50 by vibration or the like, the FPC board 50 is not easily damaged. Thus, the conductor lines 51, 52 are not easily disconnected. Therefore, a short is prevented from occurring between each of the bus bars 40, 40a and the printed circuit board 21 better than when each of the bus bars 40, 40a and the printed circuit board 21 are connected to each other through a lead wire.

When the volume of the battery cell 10 changes with charge/discharge or deterioration of the battery cell 10, the distance between the adjacent bus bars 40, 40a changes. Even in the case, the FPC board 50 is flexibly deflected, to prevent damage to the FPC board 50 and disconnection of the conductor lines 51, 52.

The bus bar 40, 40a may be respectively fixed to the electrodes 10a, 10b of the battery cells 10 with the FPC board 50 previously deflected between the adjacent bus bars 40, 40a. In the case, even if the distance between the adjacent bus bars 40, 40a increases by the increasing volume of each of the battery cells 10, the stress applied to the FPC board 50 can be relieved. This can more reliably prevent damage to the FPC board 50 and disconnection of the conductor lines 51, 52.

### (5-2) Effects of Bending the FPC Board

The number of the conductor lines 52 formed in the FPC board 50 corresponds to the number of the battery cells 10. The number of the conductor lines 52 formed in the FPC board 50 is increased with increasing the number of the battery cells 10. In this case, increasing the size of the FPC board 50 for ensuring more space for the conductor lines 52 makes it difficult to cover the FPC board 50 with the covers 80 (FIG. 5). If the FPC board 50 projects outward from the covers 80, it cannot be sufficiently protected from the external environment.

Meanwhile, the area of the FPC board 50 can be reduced by making the smaller width and pitch of each conductor line 52. However, the smaller width of the conductor line 52 causes the conductor line 52 to easily generate heat in the case of a large current flowing therethrough. The smaller pitch of the conductor line 52 easily causes a short between the adjacent conductor lines 52.

Therefore, the FPC board 50 is bent at the bending line B1 such that the first region R11 and the second region R12 of the FPC board 50 overlap each other in the present embodiment. This allows the FPC board 50 to be arranged within the covers 80 without reducing the area of the FPC board 50 even in the case of the increased number of the conductor lines 52. Accordingly, the FPC board 50 can be sufficiently protected from the external environment.

Also, the width and pitch of each conductor line 52 need not be decreased. This suppresses heat generation in the conductor line 52 in the case of a large current flowing therethrough, and prevents a short from occurring between the adjacent conductor lines 52.

### (5-3) Effects of the PTC Element

When a short occurs between each of the bus bars 40, 40a and the detecting circuit 20 or within the detecting circuit 20, a large current is generated in a short-circuited portion from the corresponding bus bar 40, 40a. When such situations in which the large current flows are continued, the battery module 100 may deteriorate by generated heat.

In the present embodiment, the PTC element 60 is connected between each of the bus bars 40, 40a and the detecting circuit 20_{—} The PTC element 60 has such resistance temperature characteristics as to have a resistance value logarithmically increasing when its temperature exceeds a certain value.

When a short occurs between the PTC element 60 and the detecting circuit 20 or within the detecting circuit 20, a large current flows through the PTC element 60. In the case, the temperature of the PTC element 60 rises by self-heating. This causes the resistance value of the PTC element 60 to increase, to inhibit the current flowing through the PTC element 60. Therefore, when a short occurs, situations in which the large current flows are quickly solved, to prevent the battery module 100 from deteriorating.

The PTC element 60 is arranged in the vicinity of each of the bus bars 40, 40a. Therefore, a short is very unlikely to occur in a region between the PTC element 60 and each of the bus bars 40, 40a, for example.

Each of the conductor lines 52 may separate from the connection terminal 22 of the printed circuit board 21 and contact the other area so that a short occurs. In this case, situations in which a large current flows are also quickly solved by the increasing resistance value of the PTC element 60 connected between the conductor lines 51 and 52.

The PTC element 60 is arranged in the vicinity of each of the battery cells 10. When the temperature of the battery cell 10 rises, the temperature of the PTC element 60 also rises. Thus, the resistance value of the PTC element 60 increases, resulting in a produced voltage drop. A voltage applied to the detecting circuit 20 decreases by the voltage drop. Therefore, the detecting circuit 20 can detect abnormal heat generated by the battery cell 10 by detecting a change in the voltage without providing another temperature detector.

More specifically, when the terminal voltage of each of the battery cells 10 is kept constant, the voltage detected by the detecting circuit 20 decreases as the temperature of the battery cell 10 rises. When each of the battery cells 10 is charged/discharged, the voltage detected by the detecting circuit 20 irregularly decreases as the temperature of the battery cell 10 rises. Abnormal heat generated by the battery cell 10 can be detected based on such voltage changes.

The PTC element 60 is arranged to correspond to each of the battery cells 10. Therefore, the battery cell 10 that generates abnormal heat can be specified by detecting the voltage drop produced by the PTC element 60.

When the detecting circuit 20 detects the abnormal heat generated by the battery cell 10, the battery ECU 101 turns the contactor 102 off, for example. This prevents the battery module 100 from generating abnormal heat.

In the present embodiment, the PTC element is connected to each of the bus bars 40 so as to be closer to each of the bus bars 40 than to bent portions at the bending lines B1 to B4 of the FPC board 50. Therefore, situations in which a large current flows are quickly solved by the increasing resistance value of the PTC element 60 even when a short occurs at the bent portions of the FPC board 50.

Each of the PTC elements 60 is arranged on the FPC board 50, so that the number of components on the printed circuit board 21 is reduced. This enables the printed circuit board 21 to be miniaturized. This further enables another circuit or another element to be provided on the printed circuit board 21.

### (6) Other Example of Bending of the FPC Board

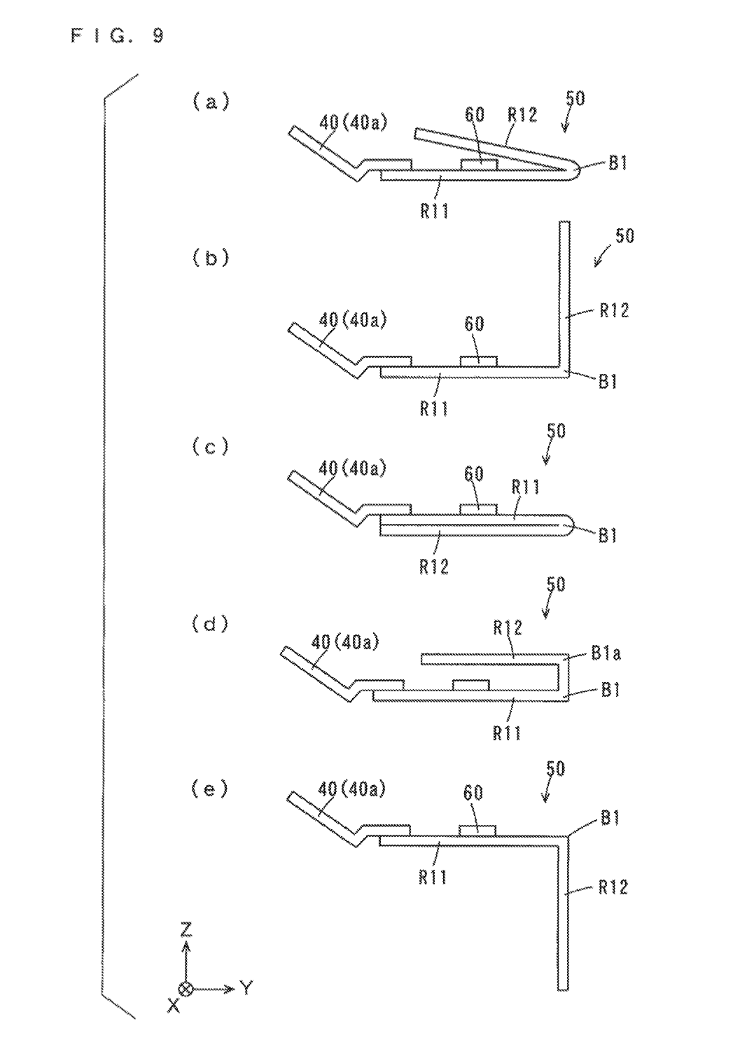

FIG. 9 is a schematic side view showing an example of bending of the FPC board 50. FIG. 9 (a) shows an example of bending of the FPC board 50 in the foregoing embodiment. FIGS. 9 (b) to (e) show other examples of bending of the FPC board 50.

In the foregoing embodiment, the FPC board 50 is bent at the bending line B1 such that the second region R12 overlaps the top surface of the first region R11 as shown in FIG. 9 (a).

The FPC board 50 may be bent at the bending line B1 such that the second region R12 is bent upward at an angle of approximately 90 degrees with the first region R11 as shown in FIG. 9 (b). The FPC board 50 may be bent at the bending line B1 such that the second region R12 overlaps the back surface of the first region R11 as shown in FIG. 9 (c). The FPC board 50 may be bent at the bending line B1 at approximately 90 degrees and further bent at a bending line B1a, which is in close proximity to and parallel to the bending line B1, at approximately 90 degrees such that a given clearance is formed between the second region R12 and the first region R11 as shown in FIG. 9 (d).

The FPC board 50 may be bent at the bending line B1 such that the second region R12 is bent downward at an angle of approximately 90 degrees with the first region R11 as shown in FIG. 9 (e).

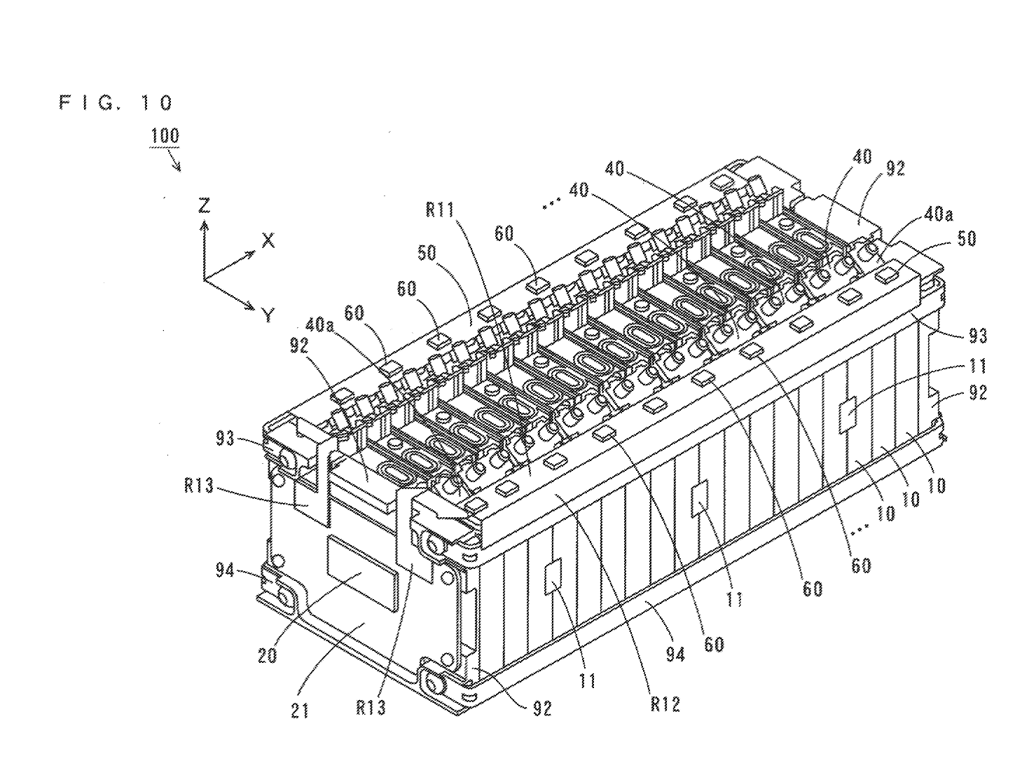

FIG. 10 is an external perspective view of the battery module 100 to which the FPC boards 50 of FIG. 9 (e) are attached. As shown in FIG. 10, the second region R12 of each FPC board 50 is arranged along the side surface of the battery module 100.

In the examples of FIGS. 9 (b) to (e), since the second region R12 of the FPC board 50 does not come in contact with the PTC element 60, stress is not applied from the second region R12 of the FPC board 50 to the PTC elements 60. This prevents the terminals of the PTC elements 60 from being separated from the conductor lines 51, 52.

In the examples of FIGS. 9 (c) and (d), an increase in the space in the height direction occupied by the FPC board 50 is suppressed as compared with the examples of FIGS. 9 (b) and (e). Particularly in the example of FIG. 9 (c), the space in the height direction occupied by the FPC board 50 can be minimized without increasing the number of bending of the FPC board 50. In the example of FIG. 9 (e), the second region R12 of the FPC board 50 is arranged along the side surface of the battery module 100 in the foregoing manner, thereby suppressing the increase in the space in the height direction occupied by the FPC board 50.

The angles at which the FPC board 50 is bent are not limited to the examples described above. The FPC board 50 may be bent at any angles at the bending line B1.

### (7) Other Examples of the FPC Board

FPC boards 50a to 50h described below may be employed instead of the above-described FPC board 50.

### (7-1)

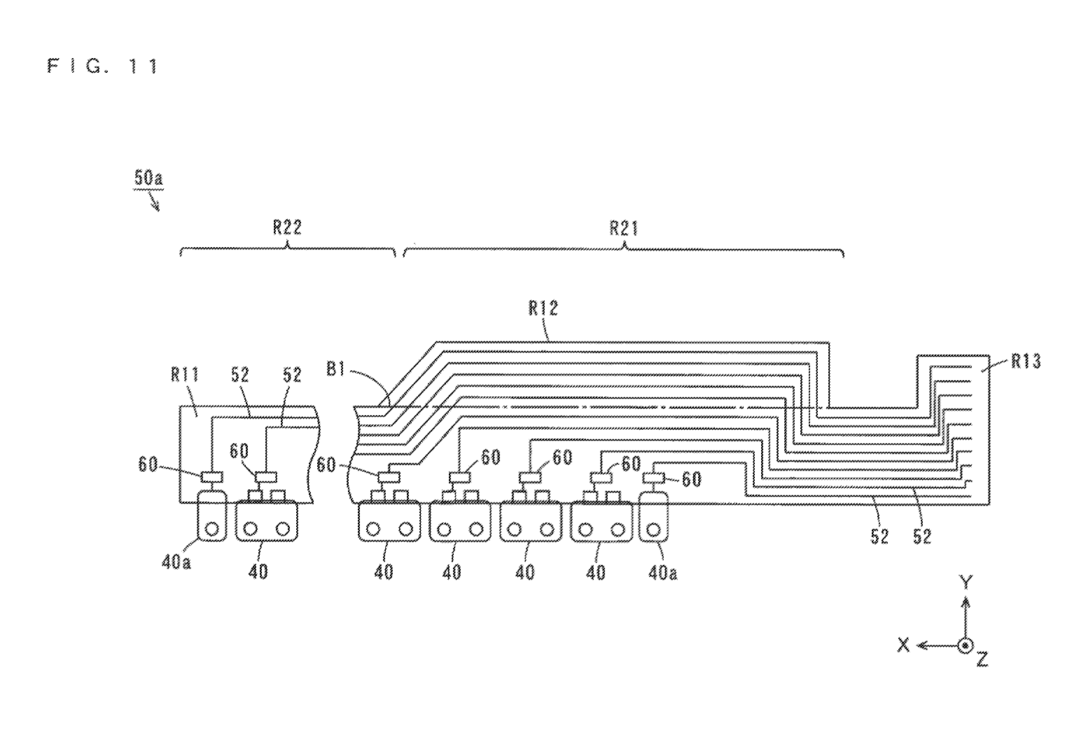

FIG. 11 is a schematic plan view of an FPC board 50a FIG. 11 shows the FPC board 50a that is not bent.

Description is made of the FPC board 50a of FIG. 11 while referring to differences from the FPC board 50 of FIG. 8.

In the FPC board 50a, the second region R12 has a smaller length (a length in a longitudinal direction), and a region of the FPC board 50a on the opposite end side of the connection region R13 is composed of only the first region R11.

Hereinafter, a region on the one end side of the FPC board 50a in which the second region R12 is provided is referred to as a one end region R21, and a region on the other end side of the FPC board 50a in which the second region R12 is not provided is referred to as the other end region R22.

Here, the one ends of the plurality of conductor lines 52 connected to the plurality of PTC elements 60, respectively, are arranged along the X-direction. Therefore, the number of the conductor lines 52 extending parallel to one another is increased in a region closer to the connection region R13. Thus, the number of the conductor lines 52 provided in the other end region R22 is smaller than the number of the conductor lines 52 provided in the one end region R21.

Therefore, the width (the length in a direction perpendicular to the longitudinal direction) of the other end region R22 is set smaller than the width (the length in the direction perpendicular to the longitudinal direction) of the one end region R21 in the FPC board 50a. This reduces useless space in the other end region R22. As a result, manufacturing cost of the FPC board 50a is decreased as described below.

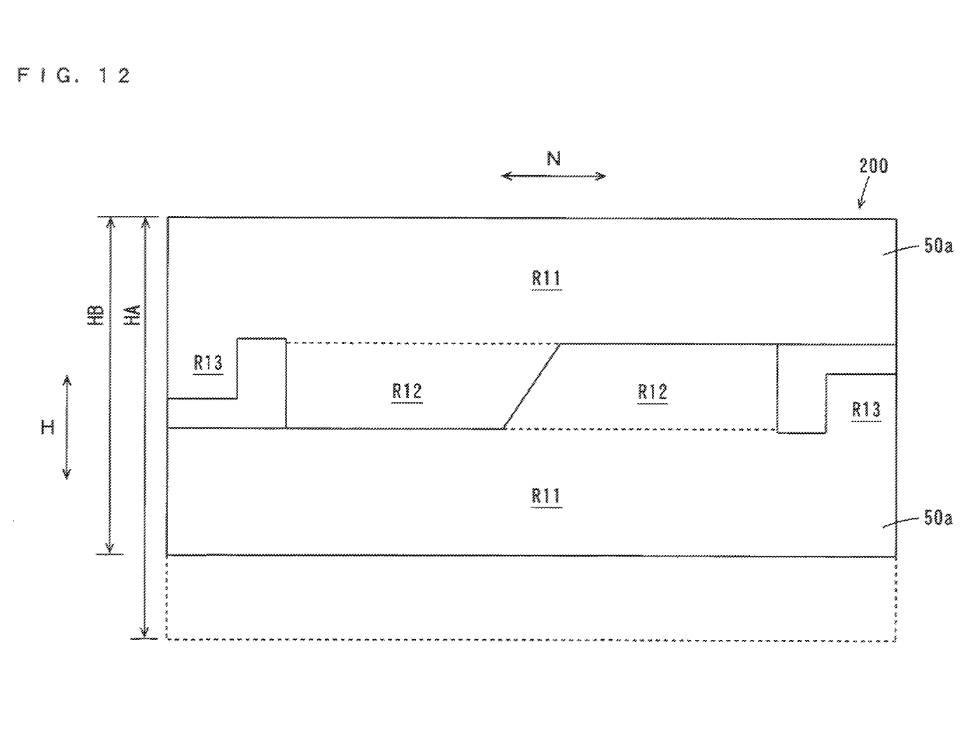

FIG. 12 is a diagram showing one example of a method of forming the FPC board 50a. In the example of FIG. 12, two FPC boards 50a are formed from a rectangular insulating layer 200 made of polyimide, for example.

As shown in FIG. 12, one FPC board 50a and the other FPC board 50a are symmetrically arranged such that the second region R12 of the one FPC board 50a and the second region R12 of the other FPC board 50a are adjacent to each other in a length direction (a direction indicated by an arrow N in the drawing) of the insulating layer 200.

In this case, the length in a width direction (a direction indicated by an arrow H in the drawing) of the insulating layer 200 required for forming the two FPC boards 50a is the sum HB of the widths (the lengths in the direction perpendicular to the longitudinal direction) of the two first regions R11 and the one second region R12.

Meanwhile, the length in the width direction of the insulating layer 200 required for forming two FPC boards 50 of FIG. 8 is the sum HA of the widths of the two first regions R11 and the two second regions R12.

As described above, the area of the insulating layer 200 required for forming the FPC board 50a is smaller than that required for forming the FPC board 50 of FIG. 8. This reduces material cost, resulting in reduced manufacturing cost.

### (7-2)

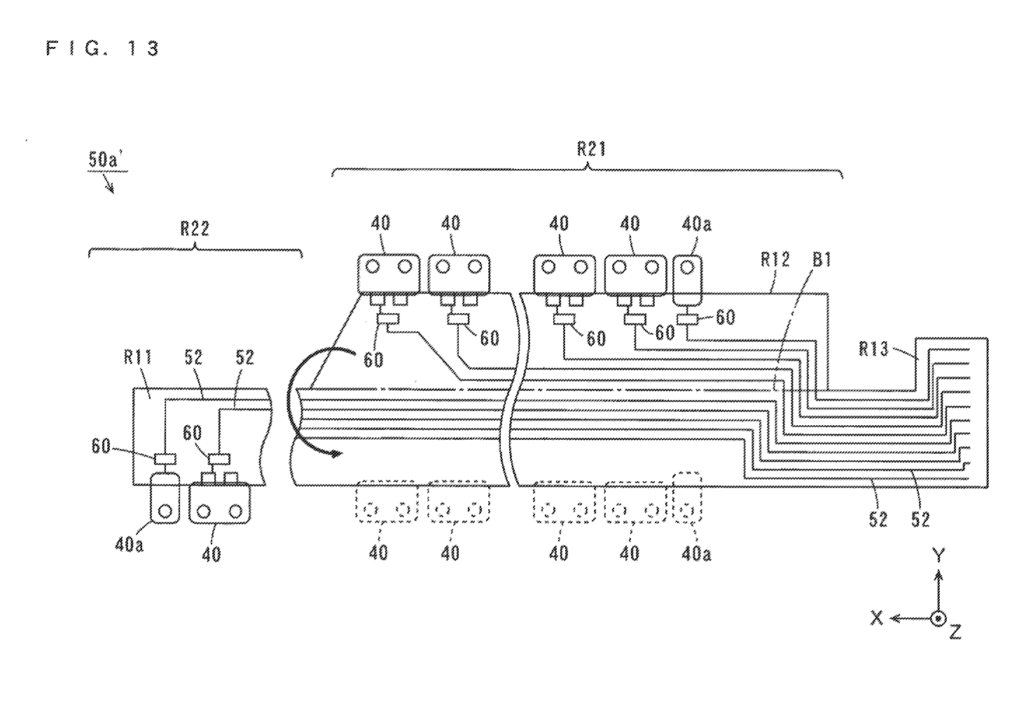

FIG. 13 is a schematic plan view of an FPC board 50a′. FIG. 13 shows the FPC board 50a′ that is not bent.

Description is made of the FPC board 50a″ of FIG. 13 while referring to differences from the FPC board 50a of FIG. 11.

The first region R11 and the second region R12 have substantially the same widths in the FPC board 50a′.

In the other end region R22, the plurality of bus bars 40, 40a are attached to the surface of the first region R11 so as to line up at given spacings along one lateral side of the first region R11 (a lateral side on the opposite side to the bending line B1). The plurality of PTC elements 60 are attached to the surface of the first region R11 at the same spacings as the spacings between the plurality of bus bars 40, 40a. The conductor line 52 connected to each PTC element 60 extends from the first region R11 to the connection region R13 while not passing through the second region R12.

In the one end region R21, the plurality of bus bars 40, 40a are attached to a surface of the second region R12 so as to line up at given spacings along one lateral side of the second region R12 (a lateral side on the opposite side to the bending line B1). The plurality of PTC elements 60 are attached to the surface of the second region R12 at the same spacings as the spacings between the plurality of bus bars 40, 40a. The conductor line 52 connected to each PTC element 60 extends from the second region R12 and passes through the first region R11 to reach the connection region R13.

The FPC board 50a′ is valley-folded at the bending line B1 in this state. This causes the second region R12 to overlap the first region R11. As described above, the first region R11 and the second region R12 have substantially the same widths. Therefore, the plurality of bus bars 40, 40a attached to the second region R12 are arranged along the one lateral side of the first region R11 in the one end region R21. Accordingly, all the bus bars 40, 40a are arranged at the given spacings along the one lateral side of the first region R11 in the one end region R21 and the other end region R22 (see the dotted lines in FIG. 13).

The FPC board 50a′ has fewer portions of intersection of the bending line B1 and the conductor lines 52 as compared with the FPC board 50a of FIG. 11. Therefore, distortion occurs in fewer portions in the conductor lines 52 when the FPC board 50a′ is bent.

### (7-3)

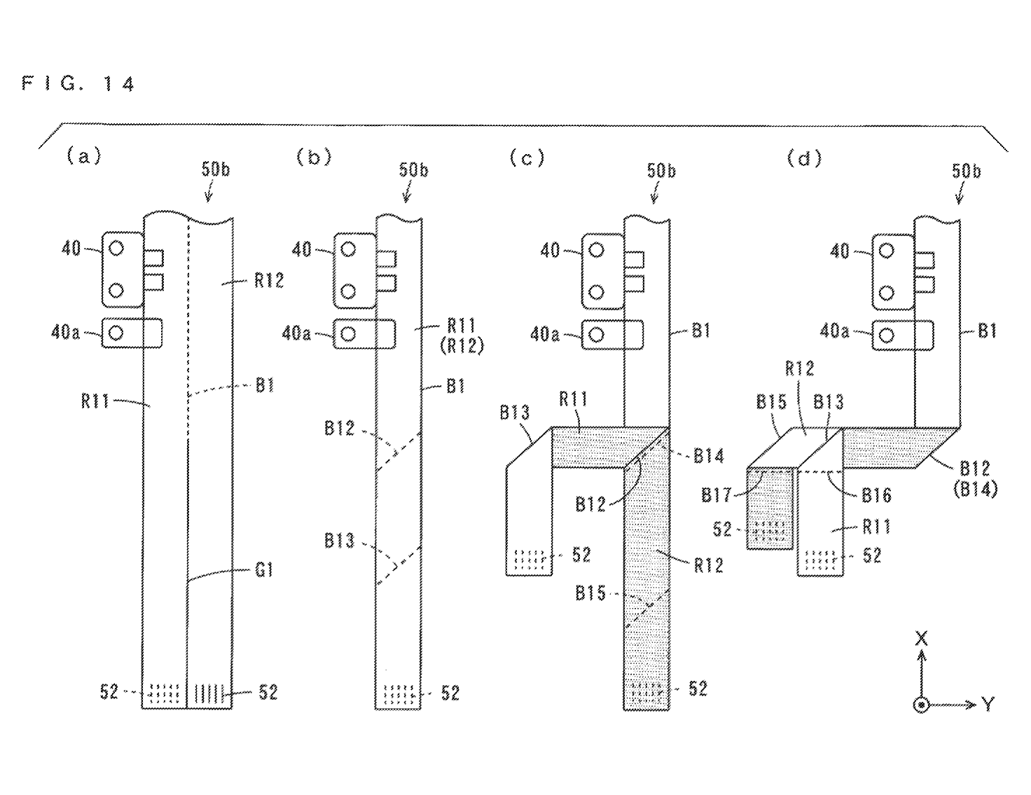

FIG. 14 is a schematic plan view of an FPC board 50b. FIG. 14 (a) shows the FPC board 50b that is not bent, and FIGS. 14 (b) to (d) show the FPC board 50b that is bent in steps. FIGS. 14 (a) to (d) do not show the PTC elements 60. Only the one ends of the conductor lines 52 are shown. The surface of the FPC board 50b indicated by hatching corresponds to the back surface of the FPC board 50b.

Description is made of the FPC board 50b of FIG. 14 while referring to differences from the FPC board 50 of FIG. 8.

In the FPC board 50b, the connection region R13 is not provided, and a slit G1 is formed along the bending line B1 from one end of the FPC board 50b, as shown in FIG. 14 (a). This separates a portion on one end side of the first region R11 and a portion on one end side of the second region R12 from each other.

The one ends of the plurality of (five in this example) conductor lines 52 formed in the first region R11 are provided to be exposed on the back surface of the one end of the first region R11. The one ends of the plurality of (five in this example) conductor lines 52 formed in the second region R12 are provided to be exposed on the top surface of the one end of the second region R12.

First, the FPC board 50b is mountain-folded at the bending line B1 such that the second region R12 overlaps the back surface of the first region R11 as shown in FIG. 14 (b). Then, the first region R11 is valley-folded at a bending line B12 that forms an angle of 45 degrees with the Y-direction while being mountain-folded at a bending line B13 parallel to the bending line B12 as shown in FIG. 14 (c).

Next, the second region R12 is mountain-folded at a bending line B14 that overlaps the bending line B12, and valley-folded at a bending line B15 parallel to the bending line B14 as shown in FIG. 14 (d). Thus, a top surface portion of the first region R11 between the bending lines 812, B13 overlaps a top surface portion of the second region R12 between the bending lines B14, B15, and the one end of the first region R11 and the one end of the second region R12 are in close proximity to each other. The one ends of the plurality of conductor lines 52 are exposed on the lower surface (the back surface in this example) of the one end of the first region R11 and the lower surface (the top surface in this example) of the one end of the second region R12.

Then, the first region R11 is bent downward at a bending line B16 parallel to the Y-direction, and the second region R12 is bent downward at a bending line B17 an the common line with the bending line B16.

In this state, the plurality of bus bars 40, 40a are attached to the plurality of battery cells 10, respectively. The plurality of conductor lines 52 that are exposed at the one end of the first region R11 and the plurality of conductor lines 52 that are exposed at the one end of the second region R12 are connected to the plurality of connection terminals 22 on the printed circuit board 21, respectively.

In the FPC board 50b, the portion at the one end of the first region R11 and the portion at the one end of the second region R12 are separated from each other, so that distortion that can occur in the FPC board 50b when being attached or vibrated is dispersed. This more reliably prevents damage to the FPC board 50b and disconnection of the conductor lines 52.

### (7-4)

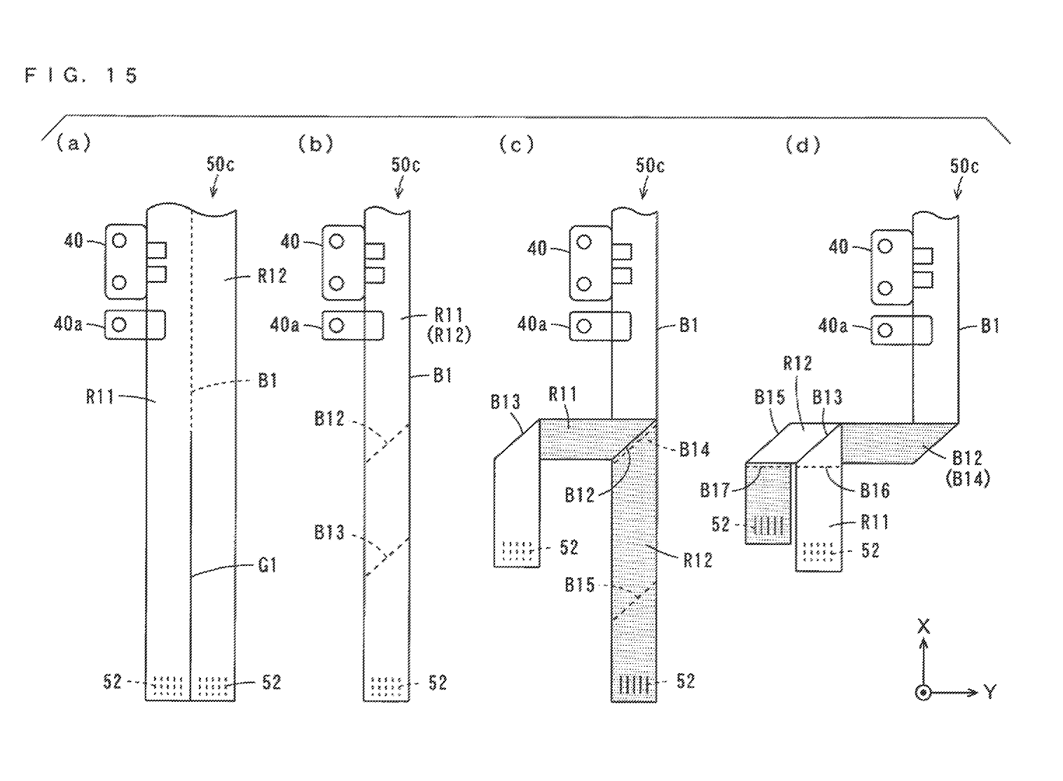

FIG. 15 is a schematic plan view of an FPC board 50c. FIG. 15 (a) shows the FPC board 50c that is not bent, and FIGS. 15 (b) to (d) show the FPC board 50c that is bent in steps. FIGS. 15 (a) to (d) do not show the PTC elements 60. Only the one ends of the conductor lines 52 are shown. The surface of the FPC board 50c indicated by hatching corresponds to the back surface of the FPC board 50c.

Description is made of the FPC board 50c of FIG. 15 while referring to differences from the FPC board 50b of FIG. 14.

As shown in FIG. 15 (a), the one ends of the plurality of conductor lines 52 formed in the second region R12 are provided to be exposed on the back surface of the one end of the second region R12 in the FPC board 50c. Similarly to the FPC board 50b of FIG. 14, the FPC board 50c is bent at the bending lines B1, B12 to B15 (FIGS. 15 (b) to (d)). In this case, the one ends of the plurality of conductor lines 52 are exposed on the lower surface (the back surface in this example) of the one end of the first region R11, and the one ends of the plurality of conductor lines 52 are exposed on the upper surface (the back surface in this example) of the one end of the second region R12 as shown in FIG. 15 (d).

The FPC board 50c is further bent downward at the bending lines B16, B17. In this state, the one end of the first region R11 is arranged at one surface of the printed circuit board 21, and the one end of the second region R12 is arranged at the other surface of the printed circuit board 21 (between the printed circuit board 21 and the end surface frame 92). In this case, the back surface of the first region R11 on which the conductor lines 52 are exposed are opposite to the one surface of the printed circuit board 21, and the back surface of the second region R12 on which the conductor lines 52 are exposed are opposite to the other surface of the printed circuit board 21.

The plurality of connection terminals corresponding to the plurality of conductor lines 52 of the first region R11 are formed on the one surface of the printed circuit board 21, and the plurality of connection terminals corresponding to the plurality of conductor lines 52 of the second region R12 are formed on the other surface of the printed circuit board 21.

The plurality of conductor lines 52 that are exposed at the one end of the first region R11 are connected to the plurality of connection terminals provided on the one surface of the printed circuit board 21, respectively, and the plurality of conductor lines 52 that are exposed at the one end of the second region R12 are connected to the plurality of connection terminals provided on the other surface of the printed circuit board 21, respectively.

In this manner, the conductor lines 52 formed in the first region R11 are connected to the one surface of the printed circuit board 21, and the conductor lines 52 formed in the second region R12 are connected to the other surface of the printed circuit board 21. Accordingly, connection strength between the FPC board 50c and the printed circuit board 21 is improved as compared with the case where the conductor lines 52 formed in the first region R11 and the second region R12 are connected to the common surface of the printed circuit board 21. This more reliably prevents disconnection and a short from occurring in the conductor lines 52.

### (7-5)

Connection terminals for connecting the thermistors 11 (FIG. 2) may be provided in the FPC board.

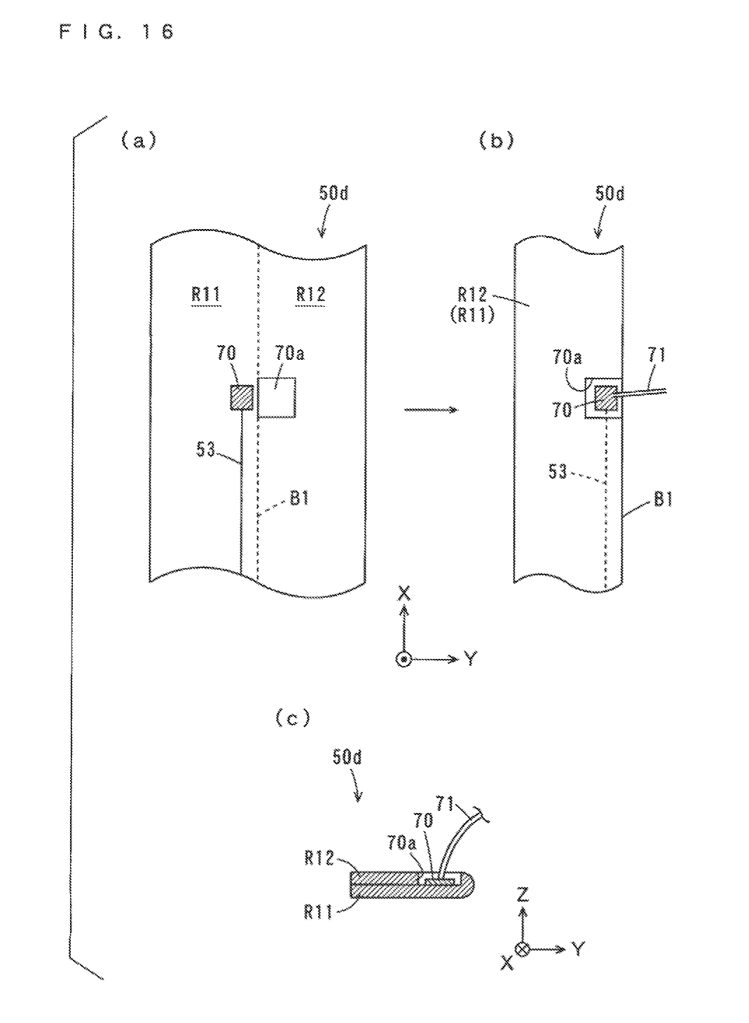

FIG. 16 shows a schematic plan view and a schematic side view of an FPC board 50d in which a connection terminal for connecting the thermistor 11 is provided. FIG. 16 (a) shows the schematic plan view of the FPC board 50d that is not bent, and FIGS. 16 (b) and (c) show the FPC board 50d that is bent. FIGS. 16 (a) to (c) do not show the conductor lines 51, 52.

Description is made of the FPC board 50d of FIG. 16 while referring to differences from the FPC board 50 of FIG. 8.

As shown in FIG. 16 (a), the connection terminal 70 for connecting the thermistor 11 is provided in the first region R11 in the FPC board 50d. A conductor line 53 is provided in the first region R11 to extend between the connection terminal 70 and the connection region R13 (see FIG. 8). An opening 70a is formed in a portion of the second region R12 adjacent to the connection terminal 70 with the bending line B1 interposed therebetween.

As shown in FIGS. 16 (b) and (c), the FPC board 50d is bent at the bending line B1 such that the second region R12 overlaps the first region R11. This causes the opening 70a to overlap the connection terminal 70, thus causing the connection terminal 70 to be exposed within the opening 70a.

In this state, one end of a connection line 71 is connected to the connection terminal 70 through the opening 70a. The other end of the connection line 71 is connected to the thermistor 11 (FIG. 2). This causes the thermistor 11 to be connected to the printed circuit board 21 (FIG. 2) through the connection line 71 and the conductor line 53.

In this manner, the thermistor 11 is connected to the FPC board 50d, so that the length of the connection line 71 can be smaller than that when the thermistor 11 is directly connected to the printed circuit board 21 through the connection line 71. Accordingly, disconnection is unlikely to occur in the connection line 71. Moreover, cost required for the connection line 71 can be reduced.

The connection line 71 is connected to the connection terminal 70 through the opening 70a formed in the second region R12, thereby reliably maintaining connection characteristics between the connection line 71 and the connection terminal 70 even through the FPC board 50d is bent.

A plurality of pairs of connection terminals 70 and openings 70a are preferably provided. In this case, each thermistor 11 can be selectively connected to the connection terminal 70 in close proximity thereto.

Similarly to the FPC board 50d, the connection terminal 70, the conductor line 53 and the opening 70a may be provided in the foregoing FPC board 50a, 50b, 50c.

### (7-6)

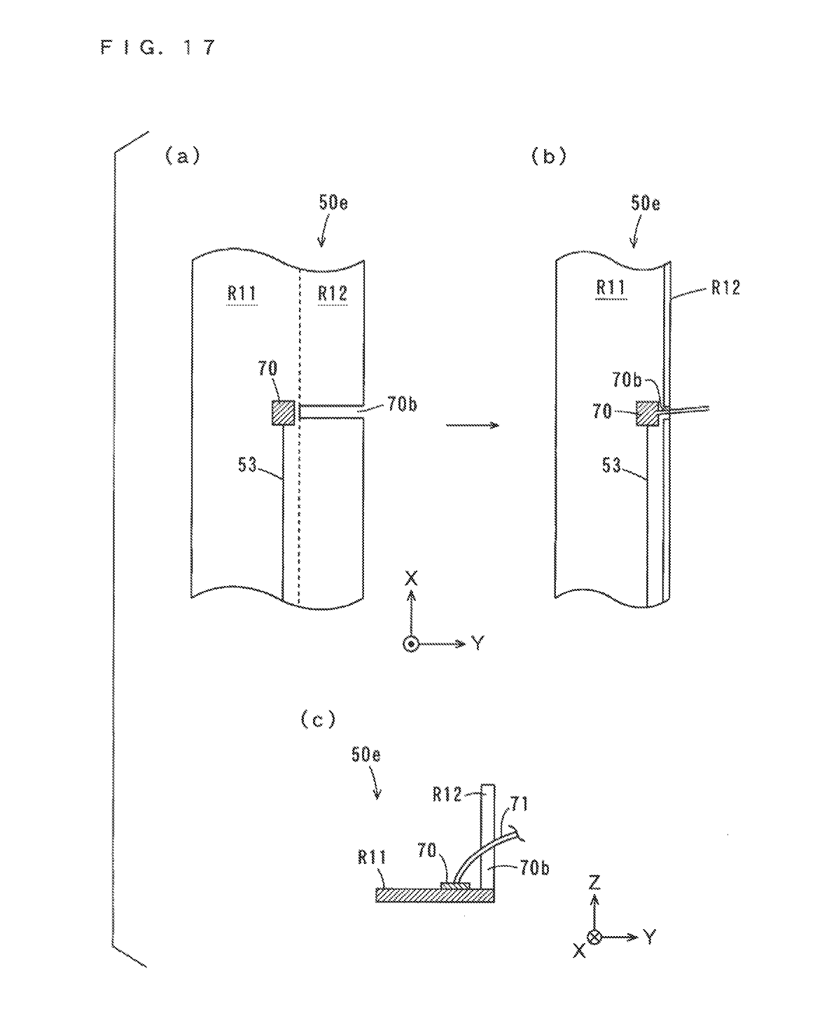

FIG. 17 shows a schematic plan view and a schematic side view of an FPC board 50e in which the connection terminal for connecting the thermistor 11 is provided. FIG. 17 (a) shows the schematic plan view of the FPC board 50e that is not bent, and FIGS. 17 (b) and (c) show the FPC board 50e that is bent. FIGS. 17 (a) to (c) do not show the conductor lines 51, 52.

Description is made of the FPC board 50e of FIG. 17 while referring to differences from the FPC board 50d of FIG. 16.

As shown in FIG. 17 (a), a slit-like cut portion 70b is formed in a portion of the second region R12 adjacent to the connection terminal 70 with the bending line B1 interposed therebetween in the FPC board 50e.

As shown in FIGS. 17 (b) and (c), the FPC board 50d is upwardly bent at the bending line B1 such that the second region R12 forms an angle of 90 degrees with the first region R11. In this state, the one end of the connection line 71 is connected to the connection terminal 70 through the cut portion 70b. The other end of the connection line 71 is connected to the thermistor 11 (FIG. 2). This causes the thermistor 11 to be connected to the printed circuit board 21 (FIG. 2) through the connection line 71 and the conductor line 53.

In this case, the connection line 71 is connected to the connection terminal 70 through the cut portion 70b formed in the second region R12, thereby reliably maintaining connection characteristics between the connection line 71 and the connection terminal 70 even though the FPC board 50d is bent.

A plurality of pairs of connection terminals 70 and openings 70b are preferably provided. In this case, each thermistor 11 can be selectively connected to the connection terminal 70 in close proximity thereto.

Similarly to the FPC board 50e, the connection terminal 70, the conductor line 53 and the cut portion 70b may be provided in the foregoing FPC board 50a, 50a′.

### (7-7)

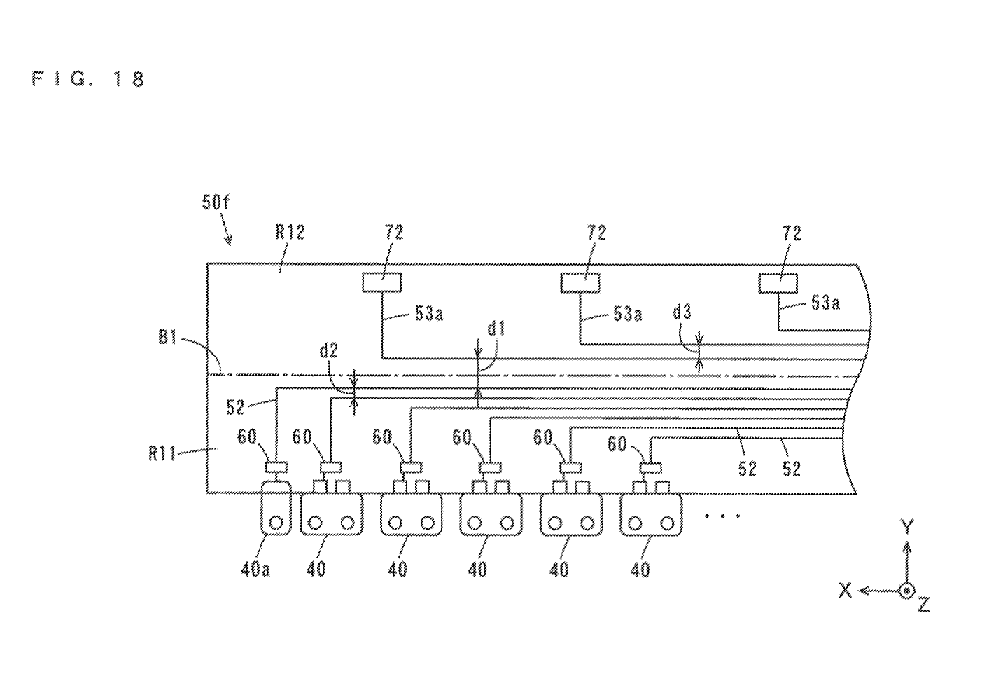

FIG. 18 is a schematic plan view of an FPC board 50f in which connection terminals for connecting the thermistors 11 are provided. FIG. 18 shows the FPC board 50f that is not bent.

Description is made of the FPC board 50f of FIG. 18 while referring to differences from the FPC board 50 of FIG. 8.

As shown in FIG. 18, a plurality of connection terminals 72 for connecting the thermistors 11 are arranged to line up along the X-direction in the second region R12 in the FPC board 50f. A plurality of conductor lines 53a are formed to extend between the plurality of connection terminals 72 and the connection region R13 (FIG. 8). The plurality of conductor lines 53a extend parallel to one another in the X-direction in the second region R12. The conductor lines 52 connected to the PTC elements 60 are provided to extend in the X-direction in the first region R11.

A distance d1 between the conductor line 52 and the conductor line 53a that are adjacent to each other with the bending line B1 interposed therebetween is larger than a distance d2 between the conductor lines 52 adjacent to each other in the first region R11, and is larger than a distance d3 between the conductor lines 53a adjacent to each other in the second region R21. Thus, the conductor lines 52, 53a are each prevented from being extensively distorted when the FPC board 50 is bent. This prevents the conductor lines 52, 53a from being damaged.

When the FPC boards 50d, 50e, 50f are used, the connection line 71 is preferably connected to the connection terminal 70, 72 through the lower side of the FPC boards 50d, 50e, 50f. In this case, the connection lines 71 are unlikely to come in contact with the exterior, thus preventing the connection lines 71 from being damaged.

### (7-8)

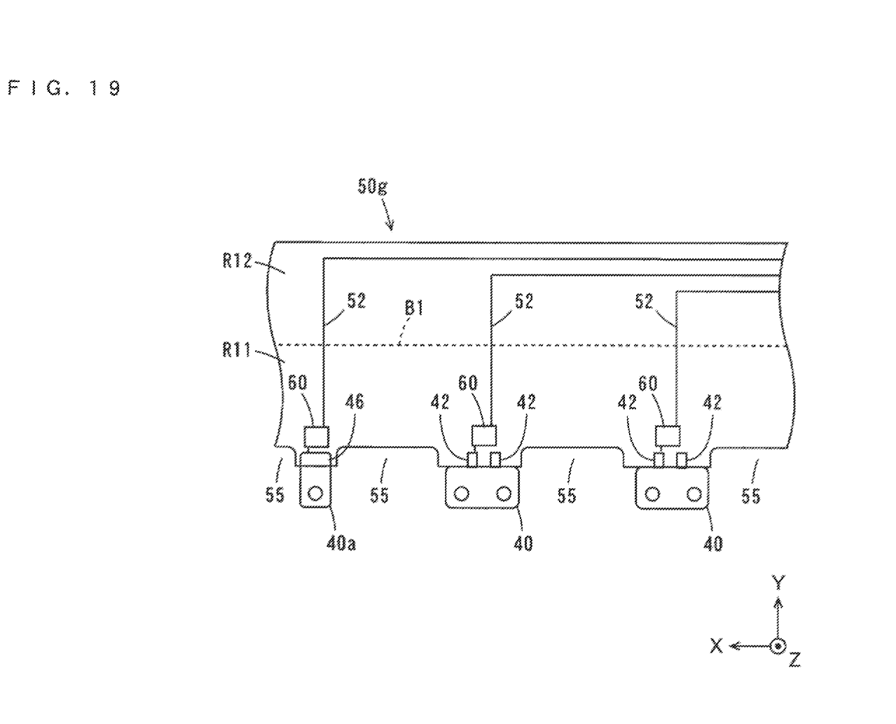

FIG. 19 is a schematic plan view of an FPC board 50g. FIG. 19 shows the FPC board 50g that is not bent.

Description is made of the FPC board 50g of FIG. 19 while referring to differences from the FPC board 50 of FIG. 8.

The FPC board 50g has notches 55 that extend in the X-direction between its portions fixed to the attachment portions 42, 46 of the bus bars 40, 40a. Edges of the notches 55 are preferably closer to the inside in the V-direction than the tips of the attachment portions 42, 46 of the bus bars 40, 40a.

In this case, the regions of the FPC board 50g between the adjacent bus bars 40, 40a can be more flexibly deflected. This more reliably prevents damage to the FPC board 50g and disconnection of the conductor lines 51, 52 even though external stress is applied to the FPC board 50g. In addition, the FPC board 50g is flexibly deflected, thereby stably fixing the FPC board 50g to bus bars 40, 40a even though the attachment positions of the bus bars 40, 40a to the battery cell 10 are shifted because of manufacturing errors and so on.

Similarly to the FPC board 50g, the notch 55 may be provided in the foregoing FPC board 50a to 50f.

### (7-9)

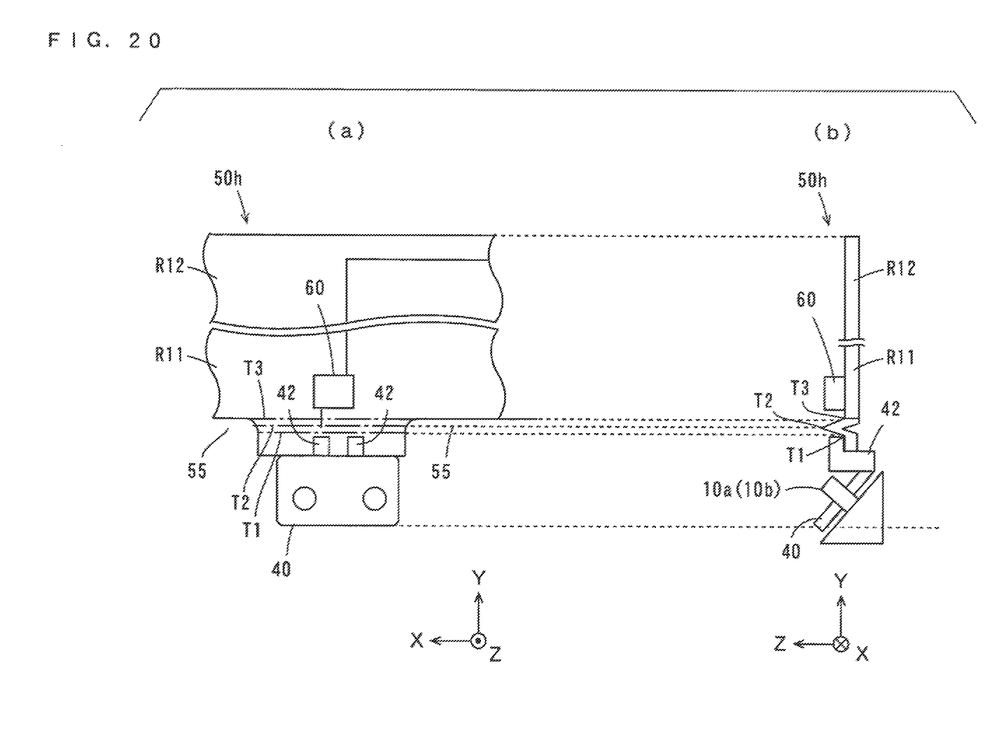

FIG. 20 (a) is a schematic plan view of an FPC board 50h, and FIG. 20 (b) is a schematic side view of the FPC board 50h. FIGS. 20 (a), (b) show the FPC board 50h that is not bent.

Description is made of the FPC board 50h of FIG. 20 while referring to differences from the FPC board 50g of FIG. 19.

Three bent portions T1, T2, T3 are formed along the X-direction in a convex region between the notches 55 in the FPC board 50h. The bent portions T1, T2, T3 are provided between the attachment portions 42, 46 of the bus bars 40, 40a and the PTC element 60. The FPC board 50h is mountain-folded at the bent portion T2, and valley-folded at the bent portions T1, T3. The bent portion T3 is preferably provided on a line extending from the edge of the notch 55.

In this case, distortion occurring in the FPC board 50h is further relieved in the bent portions T1 to T3 even though the attachment positions of the bus bars 40, 40a to the battery cells 10 are shifted because of manufacturing errors and so on. This allows the FPC board 50h to be stably fixed to the bus bars 40, 40a.

Similarly to the FPC board 50h, the notches 55 and the bent portions T1 to T3 may be provided in the foregoing FPC board 50a to 50f.

### (8) Other Examples of the Arrangement of the PTC Element

### (8-1)

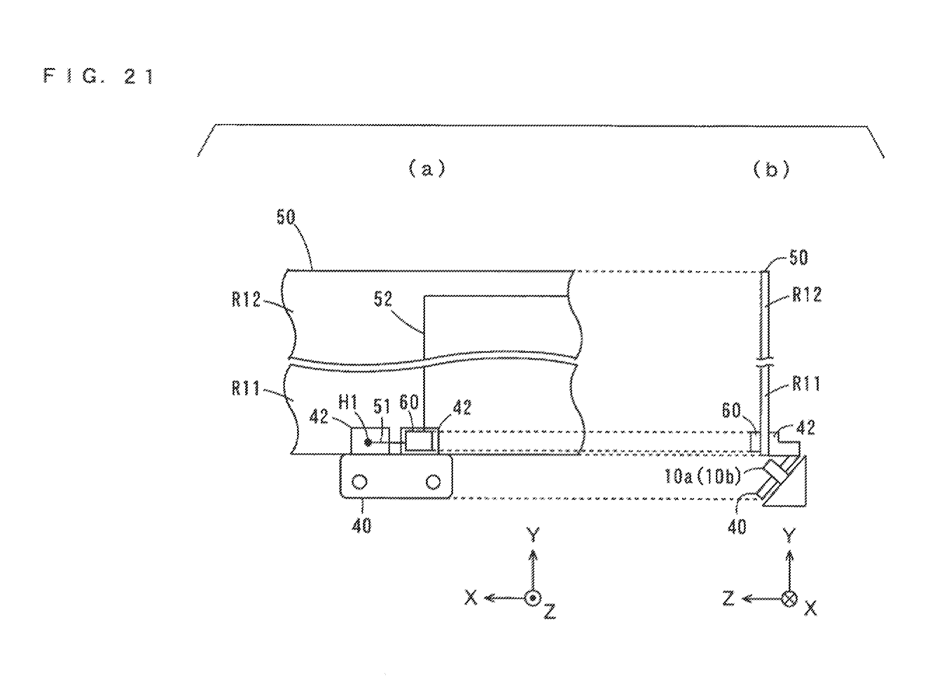

FIGS. 21 (a), (b) show a schematic plan view and a schematic side view illustrating another example of the arrangement of the PTC element 60. The example shown in FIG. 21 is different from the example of FIG. 8 in the following points.

In the example of FIGS. 21 (a), (b), the attachment portions 42, 46 of the plurality of bus bars 40, 40a are attached to the back surface of the FPC board 50. The PTC element 60 is attached to a portion of the top surface of the FPC board 50 above one of attachment portions 42 of each of bus bars 40. A through hole H1 is formed in a portion of the FPC board 50 above the other attachment portion 42 in the bus bar 40. One end of each conductor line 51 is connected to the other attachment portion 42 in the bus bar 40 via the through hole H1 and the other end of each conductor line 51 is connected to one terminal of the PTC element 60 above the one attachment portion 42 in the bus bar 40.

### (8-2)

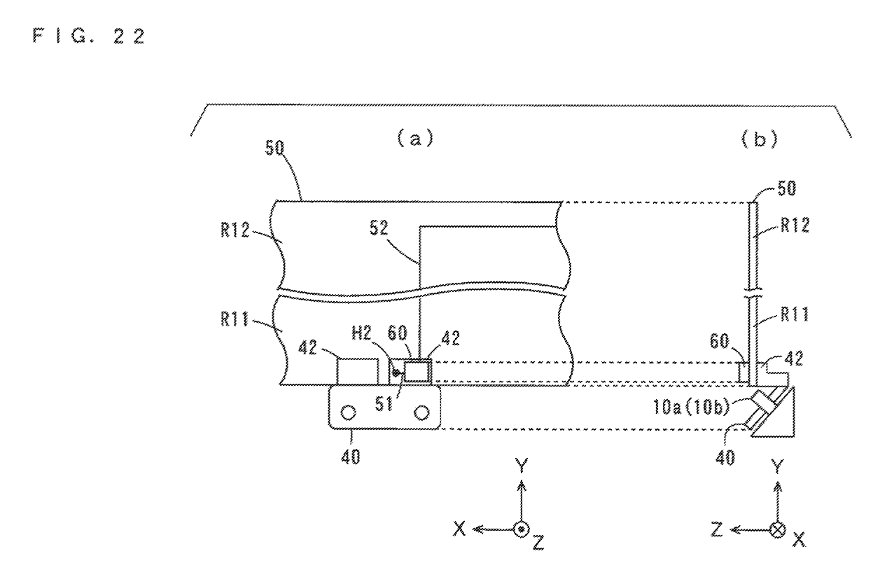

FIGS. 22 (a), (b) show a schematic plan view and a schematic side view illustrating still another example of the arrangement of the PTC element 60. The example shown in FIG. 22 is different from the example of FIG. 8 in the following points.

In the example of FIGS. 22 (a), (b), the attachment portions 42, 46 of the plurality of bus bars 40, 40a are attached to the back surface of the FPC board 50. The PTC element 60 is attached to a portion of the top surface of the FPC board 50 above one of attachment portions 42 in each of bus bars 40. A through hole H2 is formed in a portion of the FPC board 50 above the one attachment portion 42 in the bus bar 40. One end of each conductor line 51 is connected to the one attachment portion 42 in the bus bar 40 via the through hole H2 and the other end of each conductor line 51 is connected to one terminal of the PTC element 60 above the one attachment portion 42 in the bus bar 40.

During assembling, the PTC element 60 may be attached to the FPC board 50 after the bus bars 40, 40a are attached to the FPC board 50. In the case, if the FPC board 50 is deflected when the PTC element 60 is attached, the PTC element 60 is difficult to be accurately positioned on the conductor lines 51, 52.

In the examples of FIGS. 21 and 22, the PTC element 60 is attached to the portion, supported by the attachment portion 42 in the bus bar 40, of the FPC board 50. Since the portion, on which the PTC element 60 is attached, of the FPC board 50 is not deflected, the PTC element 60 can be easily and accurately connected to the conductor lines 51, 52.

In the bus bar 40a illustrated in FIG. 6 (b), the PTC element 60 may be similarly attached to a portion, above the attachment portion 46 in the bus bar 40a, of the FPC board 50. In the case, a through hole is formed in a portion above the attachment portion 46 of the FPC board 50. One end of the conductor line 51 is connected to the attachment portion 46 in the bus bar 40a via the through hole.

Similarly to the examples of FIGS. 21 and 22, the PTC element 60 may be attached to a portion of the top surface, above the attachment portion 46 in the bus bar 40a, of the FPC board 50a to 50h in the foregoing FPC board 50a to 50h.

### (9) Modifications of the Electrode Connection Hole In the Bus Bar

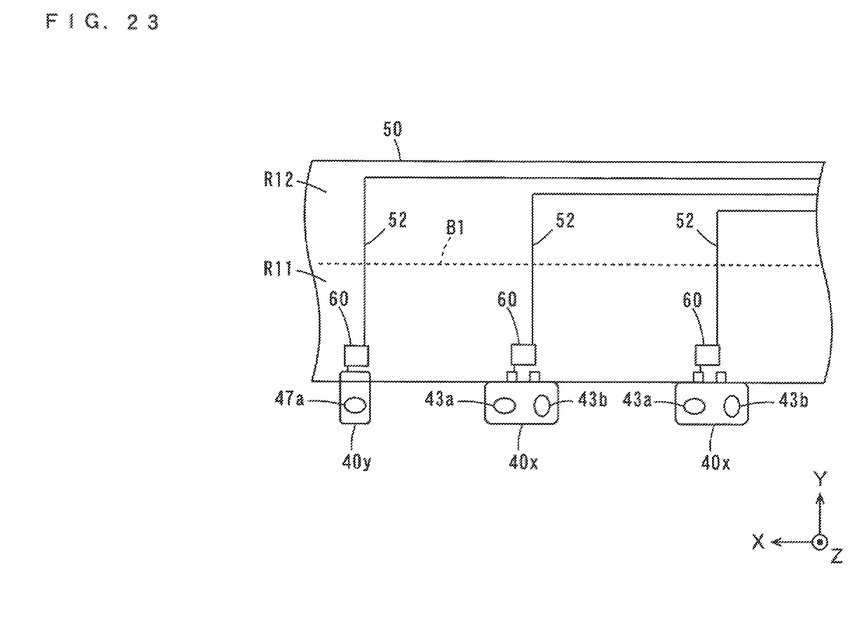

FIG. 23 is a schematic plan view showing a modification of the bus bars 40, 40a. Bus bars 40x, 40y illustrated in FIG. 23 differ from the bus bars 40, 40a in the above-mentioned embodiments in the following points.

In the bus bar 40x for two electrodes, an elliptical electrode connection hole 43a extending in the X-direction and an elliptical electrode connection hole 43b extending in the Y-direction are formed in place of the pair of circular electrode connection holes 43. In the bus bar 40y for a single electrode, an elliptical electrode connection hole 47a extending in the X-direction is formed in place of the circular electrode connection hole 47.

In this case, the bus bars 40x, 40y can be shifted in the X-direction and the Y-direction with the plus electrode 10a or the minus electrode 10b of each of the battery cells 10 inserted into the electrode connection holes 43a, 43b, 47a in the bus bar 40x, 40y. Even if the position of the plus electrode 10a or the minus electrode 10b (FIG. 3) of each of the battery cells 10 is shifted due to a manufacturing error, an increase/decrease in the volume of the battery cell 10, or the like, the positions of the bus bars 40x, 40y can be appropriately adjusted. This enables distortion occurring in the FPC board 50 to be relieved.

The shapes of the electrode connection holes 43a, 43b, 47a in the bus bars 40x, 40y may be changed, as needed. For example, the electrode connection holes 43a, 47a may be in an elliptical shape extending in the Y-direction. Alternatively, the electrode connection hole 43b may be in an elliptical shape extending in the X-direction. The electrode connection holes 43a, 43b, 47a may be in another shape such as a rectangular shape or a triangular shape.

The bus bars 40x, 40y may be attached to the foregoing FPC board 50a to 50h.

### (10) Another Example of the Battery Module

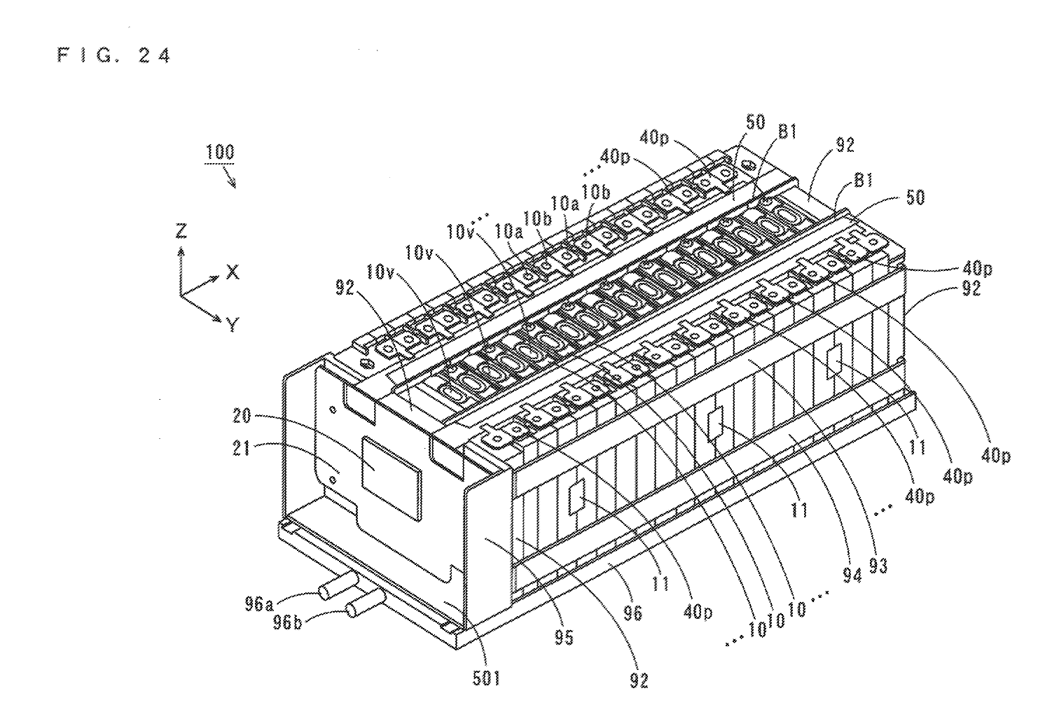

FIG. 24 is an external perspective view showing another example of the battery module 100. Description is made of the battery module 100 of FIG. 24 while referring to differences from the battery module 100 of FIG. 2.

The plus electrode 10a and the minus electrode 10b are provided to project upward in the vicinity of the one end and the other end, respectively, of the upper surface of each battery cell 10 in the battery module 100 of FIG. 24. A bus bar 40p having a flat plate shape is fitted with two adjacent electrodes 10a, lob. The electrodes 10a, 10b are laser-welded to the bus bar 40p in the state. Accordingly, the plurality of battery cells 10 are connected in series.

The plurality of bus bars 40p are arranged in two rows along the X-direction. The two FPC boards 50 are arranged in a portion between the two rows of the bus bars 40p. One FPC board 50 is arranged between the gas vent valves 10v of the plurality of battery cells 10 and one row of the bus bars 40p so as not to overlap the gas vent valves 10v of the plurality of battery cells 10. Similarly, the other FPC board 50 is arranged between the gas vent valves 10v of the plurality of battery cells 10 and the other row of the bus bars 40p so as not to overlap the gas vent valves 10v of the plurality of battery cells 10.

The one FPC board 50 is connected in common to the one row of the bus bars 40p. The other FPC board 50 is connected in common to the other row of the bus bars 40p. Each FPC board 50 is bent downward at an upper end portion of one end surface frame 92 to be connected to the printed circuit board 21.

Each FPC board 50 has the same configuration as the FPC board 50 of FIG. 7, and is bent double at the bending line B1. In this case, each FPC board 50 is bent, thus being prevented from overlapping the gas vent valves 10v even in the case of the large width of each FPC board 50. This prevents each FPC board 50 from inhibiting discharge of the gas when the internal pressure of the battery cells 10 rises to the given value to cause the gas to be discharged through the gas vent valves 10v. In addition, the FPC board 50 can be prevented from being damaged because of discharge of the gas.

A protecting member 95 having a pair of side surface portions and a bottom surface portion is attached to the end surface frame 92 so as to protect both end portions and a lower portion of the printed circuit board 21. The printed circuit board 21 is protected by being covered with the protecting member 95. The detecting circuit 20 is provided on the printed circuit board 21.

A cooling plate 96 is provided to come in contact with lower surfaces of the plurality of battery cells 10. The cooling plate 96 has a refrigerant inlet 96a and a refrigerant outlet 96b. A circulation path that communicates with the refrigerant inlet 96a and the refrigerant outlet 96b is formed within the cooling plate 96. When a refrigerant such as cooling water flows in the refrigerant inlet 96a, the refrigerant passes through the circulation path within the cooling plate 96 and flows out from the refrigerant outlet 96b. This causes the cooling plate 96 to be cooled. As a result, the plurality of battery cells 10 are cooled.

White each FPC board 50 is bent in the same manner as that in the example of FIG. 9 (a) in the example of FIG. 24, each FPC board 50 may be bent in the same manner as that in the examples of FIGS. 9 (b) to (d). The FPC boards 50 may be replaced with the above-described FPC boards 50a to 50h in the battery module 100 of FIG. 24.

### (11) Example of Connection of Two Battery Modules

### (11-1)

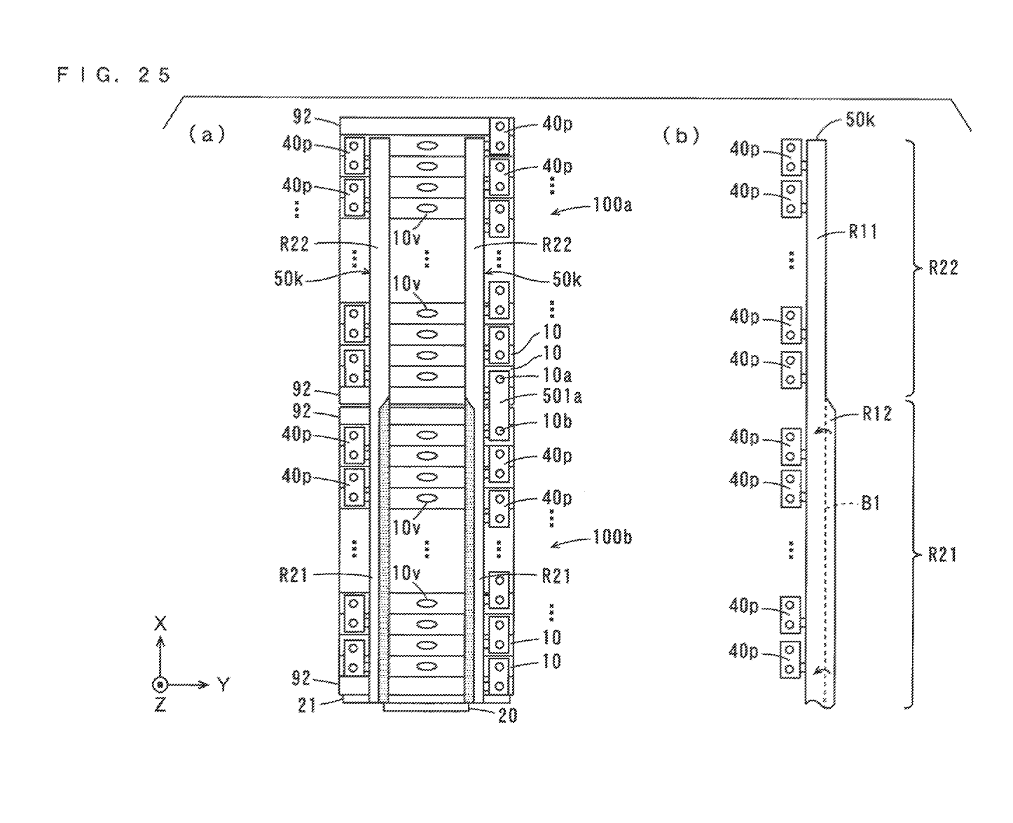

FIG. 25 is a diagram showing an example of configuration in which two battery modules 100 are connected to each other. FIG. 25 (a) is a schematic plan view of the two battery modules 100, and FIG. 25 (b) is a development view of one FPC board used in the example of FIG. 25 (a). Each battery module 100 in FIG. 25 has the same configuration as the battery module 100 of FIG. 24 except for the following points.

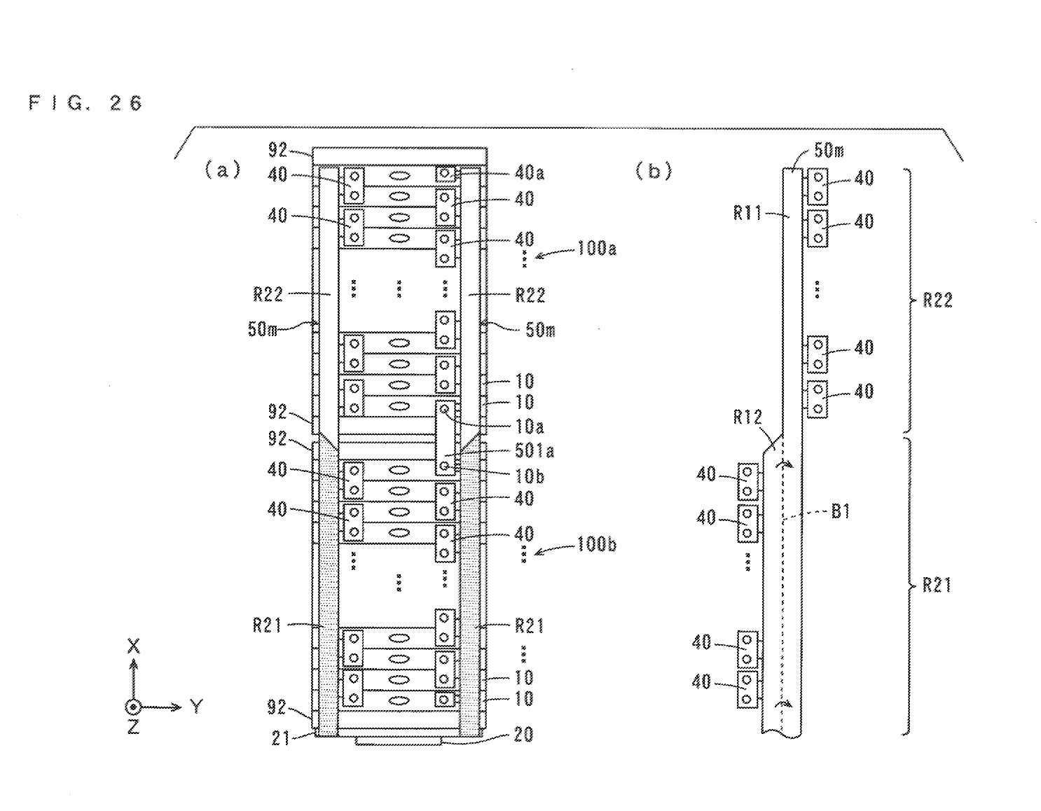

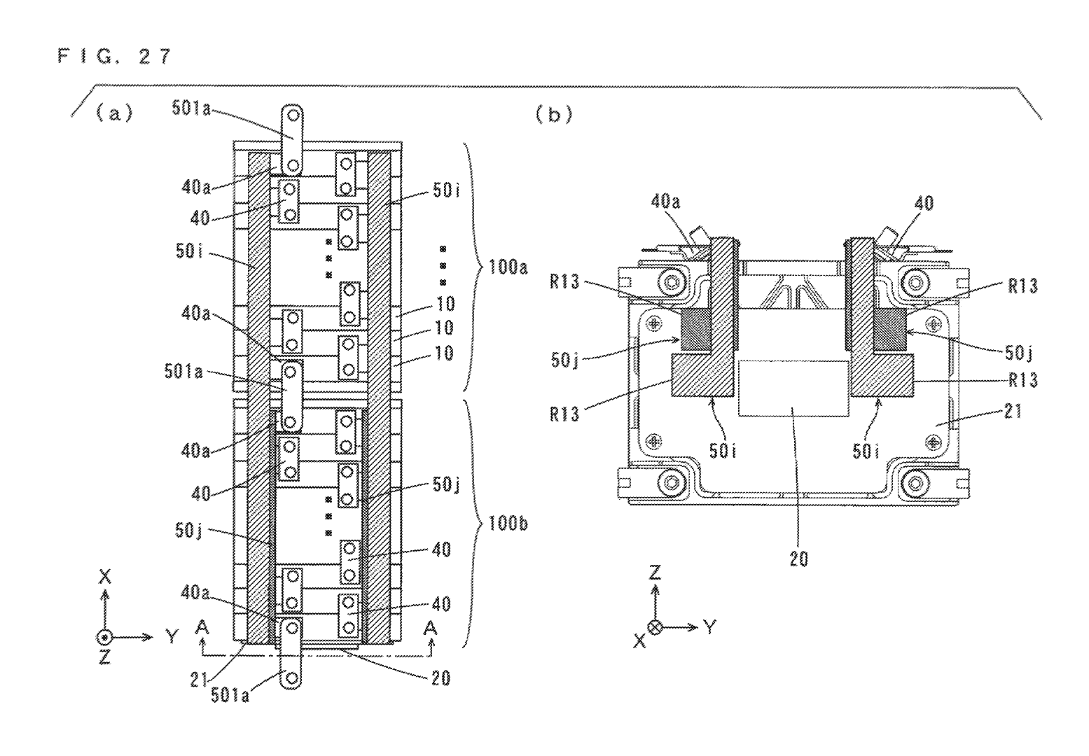

In FIG. 25, and FIGS. 26 and 27 described below, the one battery module 100 is referred to as a battery module 100a, and the other battery module 100 is referred to as a battery module 100b in order to distinguish the two battery modules 100.

As shown in FIG. 25 (a), the two battery modules 100a, 100b are arranged in a line along the X-direction (the direction in which the plurality of battery cells 10 line up). The bus bar 40p attached to the electrode 10a having the highest potential in the battery module 100a and the bus bar 40p attached to the electrode 10b having the lowest potential in the battery module 100b are connected to each other through a strip-shaped bus bar 501a. Accordingly, all the battery cells 10 of the two battery modules 100a, 100b are connected in series. The bus bar 501a corresponds to the power supply line 501 of FIG. 1. The one detecting circuit 20 and two FPC boards 50k are provided in common for the two battery modules 100a, 100b in this example. The printed circuit board 21 including the detecting circuit 20 is attached to the end surface frame 92 on an outer side of the battery module 100b. The two FPC boards 50k are provided to extend in the X-direction on the battery modules 100a, 100b, and attached to the bus bars 40p of the battery modules 100a, 100b. Each of the FPC boards 50k is connected to the printed circuit board 21.

As shown in FIG. 25 (b), each of the FPC boards 50k has the similar shape as the FPC board 50a shown in FIG. 11, and includes the one end region R21 and the other end region R22. The one end region R21 includes the first region R11 and the second region R12, and the other end region R22 includes only the first region R11. The length (the length in the longitudinal direction) of the first region R11 is substantially twice the length in the X-direction of the battery module 100, and the length (the length in the longitudinal direction) of the second region R12 is substantially equal to the length in the X-direction of the battery module 100. The other end region R22 is arranged on the battery module 100a, and the one end region R21 is arranged on the battery module 100b.

In this case, since the detecting circuit 20 and the FPC boards 50k need not be provided for each of the battery modules 100a, 100b, the simplified configuration and reduced cost of the battery system 500 of FIG. 1 are realized. In addition, the number of the detecting circuits 20 that communicate with the battery ECU 101 of FIG. 1 is reduced, thereby improving processing speed of the entire battery system 500.

Each of the FPC boards 50k is provided in common for the two battery modules 100a, 100b, so that the number of the conductor lines 52 (see FIG. 11) provided in the FPC board 50k is increased, and the width (the length in the direction perpendicular to the longitudinal direction) of the FPC board 50k is increased in this example. Even in the case, the FPC board 50k is bent, thereby allowing for a smaller area occupied by the FPC board 50k without reducing the width and pitch of the conductor line 52. Thus, each FPC board 50k is prevented from overlapping the gas vent valves 10v of the battery modules 100a, 100b. This prevents each FPC board 50k from inhibiting discharge of the gas when the internal pressure of the battery cells 10 rises to the given value to cause the gas to be discharged through the gas vent valves 10v. In addition, the FPC board 50k can be prevented from being damaged because of discharge of the gas.

The number of the conductor lines 52 (see FIG. 11) formed in the FPC board 50k is decreased with increasing distance from the printed circuit board 21 attached to the battery module 100b in this example. Therefore, the width of the FPC board 50k on the battery module 100a is set smaller than the width of the FPC board 50k on the battery module 100b. This reduces useless space and manufacturing cost of the FPC board 50k.

While the length of the second region R12 is substantially equal to the length in the X-direction of the battery module 100 in this example, the length of the second region R12 may be suitably changed according to the number of the conductor traces 52 and the arrangement thereof. That is, the second region R12 may be provided in a portion where the first region R11 cannot provide enough space for arranging increased number of the conductor traces 52.

While each FPC board 50k is arranged in the portion between the bus bars 40p arranged in the two rows in this example, the FPC boards 50k may be arranged on outer sides of the bus bars 40p arranged in the two rows.

### (11-2)

FIG. 26 is a diagram showing another example of the configuration in which the two battery modules 100 are connected to each other. FIG. 26 (a) is a schematic plan view of the two battery modules 100, and FIG. 26 (b) is a development view of one FPC board used in the example of FIG. 26 (a). Each battery module 100 in FIG. 26 has the same configuration as the battery module 100 of FIG. 2 except for the following points.

As shown in FIG. 26 (a), the two battery modules 100a, 100b are arranged in a line along the X-direction (the direction in which the plurality of battery cells 10 line up). The bus bar 40a attached to the electrode 10a having the highest potential in the battery module 100a and the bus bar 40a attached to the electrode 10b having the lowest potential in the battery module 100b are connected to each other through the strip-shaped bus bar 501a. Accordingly, all the battery cells 10 of the two battery modules 100a, 100b are connected in series. The bus bar 501a corresponds to the power supply line 501 of FIG. 1.

The one detecting circuit 20 and two FPC boards 50m are provided in common for the two battery modules 100a, 100b in this example. The printed circuit board 21 including the detecting circuit 20 is attached to the outer end surface of the battery module 100b. The two FPC boards 50m are provided to extend in the X-direction on the battery modules 100a, 100b, and attached to the bus bars 40, 40a of the battery modules 100a, 100b. Each of the FPC boards 50m is connected to the printed circuit board 21.

As shown in FIG. 26 (b), each of the FPC boards 50m has the similar shape as the FPC board 50a′ shown in FIG. 13, and includes the one end region R21 and the other end region R22. The one end region R21 includes the first region R11 and the second region R12, and the other end region R22 includes only the first region R11. The first region R11 and the second region R12 have substantially the same widths. The length of the first region R11 is substantially twice the length in the X-direction of the battery module 100, and the length of the second region R12 is substantially equal to the length in the X-direction of the battery module 100.

The other end region R22 is arranged on the battery module 100a, and the one end region R21 is arranged on the battery module 100b. The bus bars 40, 40a of the battery module 100a are attached to the first region R11 of the other end region R22 of each FPC board 50m, and the bus bars 40, 40a of the battery module 100b are attached to the second region R12 of the other end region R21 of each FPC board 50m.

In this case, since the detecting circuit 20 and the FPC boards 50m need not be provided for each of the battery modules 100a, 100b, the simplified configuration and reduced cost of the battery system 500 of FIG. 1 are realized. In addition, the number of the detecting circuits 20 that communicate with the battery ECU 101 of FIG. 1 is reduced, thereby improving processing speed of the entire battery system 500.

Each FPC board 50m is provided in common for the two battery modules 100a, 100b, so that the number of the conductor lines 52 (see FIG. 11) formed in the FPC board 50m is increased, and the width of the FPC board 50m (the length in the direction perpendicular to the longitudinal direction) is increased in this example. Even in the case, the FPC board 50m is bent, thereby allowing for a smaller area occupied by the FPC board 50m without reducing the width and pitch of the conductor line 52.

The number of the conductor lines 52 (see FIG. 11) formed in the FPC board 50m is decreased with increasing distance from the printed circuit board 21 attached to the battery module 100b in this example. Therefore, the width of the FPC board 50m on the battery module 100a is set smaller than the width of the FPC board 50m on the battery module 100b. This reduces useless space and manufacturing cost of the FPC board 50m.

The FPC board 50m has fewer portions of intersection of the bending line B1 and the conductor lines 52 as compared with the FPC board 50k of FIG. 25. Therefore, distortion occurs in fewer portions in the conductor lines 52 when the FPC board 50m is bent.

While the length of the second region R12 is substantially equal to the length in the X-direction of the battery module 100 in this example, the length of the second region R12 may be suitably changed according to the number of the conductor traces 52 and the arrangement thereof. That is, the second region R12 may be provided in a portion where the first region R11 cannot provide enough space for arranging increased number of the conductor traces 52.

While the FPC boards 50m are arranged on the outer sides of the bus bars 40, 40a arranged in the two rows in this example, the FPC boards 50m may be arranged in the portion between the bus bars 40, 40a arranged in the two rows.

The FPC boards 50m may be replaced with the FPC boards 50k of FIG. 25 in the battery modules 100a, 100b of FIG. 26. Conversely, the FPC boards 50k may be replaced with the FPC boards 50m of FIG. 26 in the battery modules 100a, 100b of FIG. 25.

In the battery modules 100a, 100b of FIGS. 25 and 26, the FPC boards 50k, 50m may be replaced with the FPC boards 50, 50b to 50h. Note that the length in the X-direction of each of the FPC boards 50, 50b to 50h is set to be the same as the length of each of the FPC boards 50k, 50m when the FPC boards 50k, 50m are replaced with the FPC boards 50, 50b to 50h.

While the one detecting circuit 20 and the two FPC boards 50k or the two FPC boards 50m are provided in common for the two battery modules 100a, 100b in the examples of FIGS. 25 and 26, the one detecting circuit 20 and the two FPC boards 50k or the two FPC boards 50m may be provided in common for three or more battery modules.

### (11-3)

FIG. 27 shows a schematic plan view and a schematic side view showing another example of the configuration in which the two battery modules 100 are connected to each other. FIG. 27 (b) shows a side surface of one of the battery modules 100 seen from the line A-A of FIG. (a). Each of the battery modules 100 in FIG. 27 has the same configuration as the battery module 100 of FIG. 2 except for the following points.

As shown in FIG. 27 (a), two battery modules 100a, 100b are arranged in a line along the X-direction (the direction in which the plurality of battery cells 10 are arranged).

Between the two battery modules 100a, 100b, two bus bars 40a provided at the ends that are in close proximity to each other are connected via a strip-shaped bus bar 501a. Thus, all the battery cells 10 of the two battery modules 100a, 100b are connected in series. The bus bar 501a in this example corresponds to the power supply line 501 of FIG. 1. FIG. 27 (b) does not show the bus bar 501a.

In this example, one detecting circuit 20 is provided corresponding to the two battery modules 100a, 100b. The printed circuit board 21 including the detecting circuit 20 is attached to an outer end surface of the battery module 100b.

The battery module 100a includes FPC boards 50i instead of the FPC boards 50, and the battery module 100b includes FPC boards 50j instead of the FPC boards 50.

The FPC boards 50i, 50j are different from the FPC board 50 of FIG. 8 in the following points. The FPC boards 50i, 50j are not bent at the bending line B1 (FIG. 8). The length of the FPC board 50i is approximately twice as long as the FPC board 50 in the X-direction.

The two FPC boards 50j of the battery module 100b extend in the X-direction on the upper surface of the battery module 100b, and connection regions R13 of the two FPC boards 50j are connected to the common printed circuit board 21 (FIG. 27 (b)). The two FPC boards 50i of the battery module 100a extend in the X-direction on the upper surface of the battery module 100a, and further extend in the X-direction on the upper surface of the battery module 100b to overlap the FPC boards 50j, respectively. In the state, the connection regions R13 of the two FPC boards 50i are connected to the common printed circuit board 21 (FIG. 27 (b)).

In this manner, the two FPC boards 50i, 50j of the battery modules 100a, 100b are connected to the common printed circuit board 21. This causes the plurality of bus bars 40, 40a of the battery modules 100a, 100b to be electrically connected to the detecting circuit 20. Accordingly, the detecting circuit 20 is used in common in the two battery modules 100a, 100b.

The FPC board 50i is an example of a first substrate, and the FPC board 50j is an example of a second substrate. The FPC boards 50i, 50j are arranged to overlap each other, thus being arranged on different planes.

In this case, the detecting circuit 20 need not be provided for each of the battery modules 100a, 100b, thus allowing for the simplified configuration and lower cost of the battery system 500 of FIG. 1. In addition, the number of the detecting circuits 20 that communicate with the battery ECU 101 of FIG. 1 is reduced, thereby improving processing speed of the entire battery system 500.

In this example, the FPC boards 50i, 50j are arranged to overlap each other on the upper surface of the battery module 100b. Thus, more space can be saved as compared with a case where the FPC boards 50i, 50j are arranged to line up on a common plane.

In this example, the foregoing FPC boards 50, 50a to 50h, 50k, 50m may be used instead of the FPC boards 50i, 50j. Note that the length of the FPC board 50, 50a to 50h in the X-direction has to be the same as that of the FPC board 50i in the case of employing the FPC board 50, 50a to 50h instead of the FPC board 50i.

While the one detecting circuit 20 is provided in common for the two battery modules 100a, 100b, and the two FPC boards 50i, 50j are arranged to overlap each other in the example of FIG. 27, the one detecting circuit 20 may be provided in common for three or more battery modules, and three or more FPC boards may be provided to overlap one another.

### (12) Still Other Modifications

### (12-1)

Although in the above-mentioned embodiment, the battery cells 10 are connected in series, the present invention is not limited to the same. For example, parts or all of the battery cells 10 may be connected in parallel. Alternatively, the number of battery cells 10 connected in series may be set to obtain a required voltage, and the number of battery cells 10 connected in parallel may be set to obtain a required current.

### (12-2)

A fuse for cutting off a current when the current has a value greater than a certain value may be used instead of the PTC element 60. A self-recovering micro fuse (SRF) for automatically recovering from an off state to an on state by a dielectrophoretic force of conducting particles may be used as the fuse.

### (12-3)

Although in the above-mentioned embodiment, the structures of the bus bars 40, 40a manufactured by forming a through hole in a metallic plate and subjecting the plate to bending or the like have been described (see FIG. 6), the bus bars 40, 40a need not necessarily be composed of a metallic plate.

For example, a structure in which a pair of electrode connection holes 43 corresponding to the respective electrodes 10a, 10b of the battery cells 10 is formed in a metallic block having a substantially rectangular parallelepiped shape may be used instead of the bus bar 40 illustrated in FIG. 6 (a).

In this case, the plus electrode 10a and the minus electrode 10b of the adjacent battery cells 10 are fitted in the pair of electrode connection holes 43 formed in the bus bar 40. Each of the electrodes 10a, 10b is subjected to caulking in this state so that the bus bar 40 is attached to the battery cell 10.

A structure in which an electrode connection hole 47 corresponding to the plus electrode 10a or the minus electrode 10b of the battery cell 10 is formed in a metallic block having a cubic shape may be used instead of the bus bar 40a illustrated in FIG. 6 (b).

In this case, the plus electrode 10a or the minus electrode 10b of the battery cell 10 is fitted in the electrode connection hole 47 formed in the bus bar 40a. The plus electrode 10a or the minus electrode 10b is subjected to caulking in this state so that the bus bar 40a is attached to the battery cell 10.

### (12-4)

In the above-mentioned embodiment, the terminal voltage of each of the battery cells 10 in the battery module 100 is detected via the conductor lines 51, 52. If a nickel hydrogen battery, for example, is used as the battery cell 10, however, a terminal voltage of the battery module 100 may be detected via the conductor lines 51, 52. In the case, there may be provided only the conductor lines 51, 52 and the PTC element 60, which corresponds to the bus bar 40a attached to each of the battery cells 10 (the first battery cell 10 and the eighteenth battery cell 10) arranged at both the ends of the battery module 10, of the plurality of conductor lines 51, 52 and the plurality of PTC elements 60. Voltage detection lines may be directly connected, respectively, to the minus electrode 10b of the first battery cell 10 and the plus electrode 10a of the eighteenth battery cell 10.

### (12-5)

While the battery cells 10 each having the flat and substantially rectangular parallelepiped shape are used as the battery cells constituting the battery module in the foregoing embodiments, the present invention is not limited to the same. Battery cells each having a columnar shape or laminate-type battery cells may be used as the battery cells constituting the battery module.

The laminate-type battery cell is prepared as follows, for example. First, a cell element in which a positive electrode and a negative electrode are arranged with a separator sandwiched therebetween is housed in a bag made of a resin film. Then, the bag with the cell element housed therein is sealed, and the enclosed space is filled with an electrolytic solution, so that the laminate-type battery cell is prepared.

### (13) Specific Example of Arrangement of the Battery System

### (13-1)

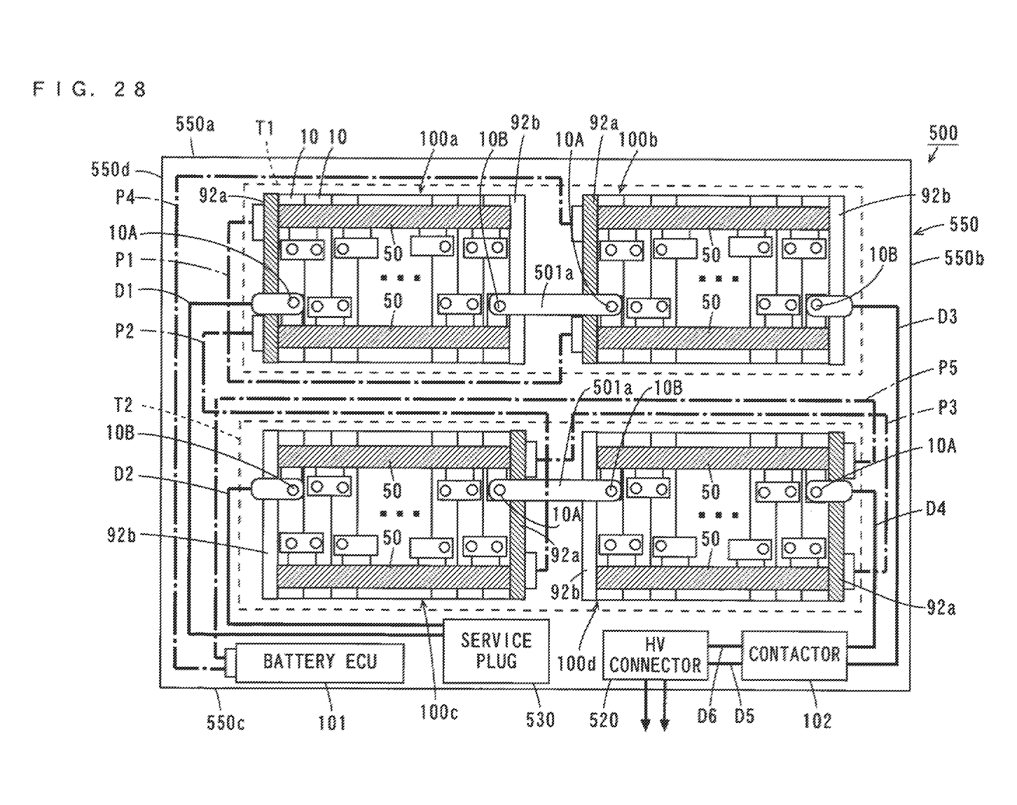

FIG. 28 is a schematic plan view showing a specific example of arrangement of the battery module 500.

The battery system 500 of FIG. 28 includes four battery modules 100, the battery ECU 101, the contactor 102, an HV (High Voltage) connector 520 and a service plug 530. Each of the battery modules 100 has the same configuration as the battery module 100 of FIG. 2.

In the following description, the four battery modules 100 are referred to as battery modules 100a, 100b, 100c, 100d, respectively. In the pairs of end surface frames 92 provided in the battery modules 100a, 100b, 100c, 100d, respectively, the end surface frame 92 to which the printed circuit board 21 (FIG. 2) is attached is referred to as an end surface frame 92a, and the end surface frame 92 to which the printed circuit board 21 is not attached is referred to as an end surface frame 92b. The end surface frames 92a are indicated by hatching in FIG. 28.

The battery modules 100a, 100b, 100c, 100d, the battery ECU 101, the contactor 102, the HV connector 520 and the service plug 530 are housed in a box-shaped casing 550.

The casing 550 has side surface portions 550a, 550b, 550c, 550d. The side surface portions 550a, 550c are parallel to each other. The side surface portions 550b, 550d are parallel to each other and perpendicular to the side surface portions 550a, 550c.

Within the casing 550, the battery modules 100a, 100b are arranged to line up in a row at a given spacing. In this case, the battery modules 100a, 100b are arranged such that the end surface frame 92b of the battery module 100a and the end surface frame 92a of the battery module 100b face each other. The battery modules 100c, 100d are arranged to line up in a row at a given spacing. In this case, the battery modules 100c, 100d are arranged such that the end surface frame 92a of the battery module 100c and the end surface frame 92b of the battery module 100d face each other. Hereinafter, the battery modules 100a, 100b arranged to line up in a row are referred to as a module row T1, and the battery modules 100c, 100d arranged to line up in a row are referred to as a module row T2.

The module row T1 is arranged along the side surface portion 550a, and the module row T2 is arranged parallel to the module row T1 within the casing 550. The end surface frame 92a of the battery module 100a in the module row T1 is directed to the side surface portion 550d, and the end surface frame 92b of the battery module 100b is directed to the side surface portion 550b. The end surface frame 92b of the battery module 100c in the module row T2 is directed to the side surface portion 550d, and the end surface frame 92a of the battery module 100d is directed to the side surface portion 550b.

The battery ECU 101, the service plug 530, the HV connector 520 and the contactor 102 are arranged to line up in this order from the side surface portion 550d toward the side surface portion 550b in a region between the module row T2 and the side surface portion 550c.

In each of the battery modules 100a, 100b, 100c, 100d, the potential of the plus electrode 10a (FIG. 3) of the battery cell 10 (the eighteenth battery cell 10) adjacent to the end surface frame 92a is the highest, and the potential of the minus electrode 10b (FIG. 3) of the battery cell 10 (the first battery cell 10) adjacent to the end surface frame 92b is the lowest. Hereinafter, the plus electrode 10a having the highest potential in each of the battery modules 100a to 100d is referred to as a high potential electrode 10A, and the minus electrode 10b having the lowest potential in each of the battery modules 100a to 100d is referred to as a low potential electrode 10B.

The low potential electrode 10B of the battery module 100a and the high potential electrode 10A of the battery module 100b are connected to each other through the strip-shaped bus bar 501a. The high potential electrode 10A of the battery module 100c and the low potential electrode 10B of the battery module 100d are connected to each other through the strip-shaped bus bar 501a. The bus bars 501a correspond to the power supply lines 501 of FIG. 1. Instead of the bus bar 501a, another connection member such as a harness or a lead wire may be used.

The high potential electrode 10A of the battery module 100a is connected to the service plug 530 through a power supply line D1, and the low potential electrode 10B of the battery module 100c is connected to the service plug 530 through a power supply line D2. The power supply lines D1, D2 correspond to the power supply lines 501 of FIG. 1. When the service plug 530 is turned on, the battery modules 100a, 100b, 100c, 100d are connected in series. In this case, the potential of the high potential electrode 10A of the battery module 100d is the highest, and the potential of the low potential electrode 10B of the battery module 100b is the lowest.

The service plug 530 is turned off by a worker during maintenance of the battery system 500, for example. When the service plug 530 is turned off, the series circuit composed of the battery modules 100a, 100h and the series circuit composed of the battery modules 100c, 100d are electrically separated from each other. When the battery modules 100a, 100b, 100c, 100d have equal voltages, the total voltage of the series circuit composed of the battery modules 100a, 100h is equal to the total voltage of the series circuit composed of the battery modules 100c, 100d. This prevents a high voltage from being generated in the battery system 500 during maintenance.

The low potential electrode 10B of the battery module 100b is connected to the contactor 102 through a power supply line D3, and the high potential electrode 10A of the battery module 100d is connected to the contactor 102 through a power supply line D4. The contactor 102 is connected to the HV connector 520 through power supply lines D5, D6. The power supply lines D3 to D6 correspond to the power supply lines 501 of FIG. 1. The HV connector 520 is connected to the load such as the motor of the electric vehicle.

When the contactor 102 is turned on, the battery module 100b is connected to the HV connector 520 through the power supply lines D3, D5 while the battery module 100d is connected to the HV connector 520 through the power supply lines D4, D6. That is, the battery modules 100a, 100b, 100c, 100d and the load connected to the HV connector 520 form a series circuit. Accordingly, with the contactor 102 turned on, electric power is supplied from the battery modules 100a, 100b, 100c, 100d to the load, and the battery modules 100a, 100b, 100c, 100d are charged.

When the contactor 102 is turned off, the connection between the battery module 100b and the HV connector 520 and the connection between the battery module 100d and the HV connector 520 are cut off.

The printed circuit board 21 (FIG. 2) of the battery module 100a and the printed circuit board 21 of the battery module 100b are connected to each other through a communication line P1. The printed circuit board 21 of the battery module 100a and the printed circuit board 21 of the battery module 100c are connected to each other through a communication line P2. The printed circuit board 21 of the battery module 100c and the printed circuit board 21 of the battery module 100d are connected to each other through a communication line P3. The printed circuit board 21 of the battery module 100b is connected to the battery ECU 101 through a communication line P4, and the printed circuit board 21 of the battery module 100d is connected to the battery ECU 101 through a communication line P5.

As described above, information (the voltage, current and temperature) about the plurality of battery cells 10 is detected by the detecting circuit 20 (FIG. 2) on the printed circuit board 21 in each of the battery modules 100a, 100b, 100c, 100d. Hereinafter, the information about the plurality of battery cells 10 detected by the detecting circuit 20 is referred to as cell information.

The cell information detected by the detecting circuit 20 of the battery module 100a is given to the battery ECU 101 through the communication lines P2, P3, P5. A prescribed control signal is given from the battery ECU 101 to the printed circuit board 21 of the battery module 100a through the communication lines P4, P1.

The cell information detected by the detecting circuit 20 of the battery module 100b is given to the battery ECU 101 through the communication lines P1, P2, P3, P5. A prescribed control signal is given from the battery ECU 101 to the printed circuit board 21 of the battery module 100b through the communication line P4.

The cell information detected by the detecting circuit 20 of the battery module 100c is given to the battery ECU 101 through the communication lines P3, P5. A prescribed control signal is given from the battery ECU 101 to the printed circuit board 21 of the battery module 100c through the communication lines P4, P1, P2.

The cell information detected by the detecting circuit 20 of the battery module 100d is given to the battery ECU 101 through the communication line P5. A prescribed control signal is given from the battery ECU 101 to the printed circuit board 21 of the battery module 100d through the communication lines P4, P1, P2 P3.

The battery module 100 of FIG. 24 may be used instead of the battery module 100 of FIG. 2 in the battery system 500 of FIG. 28.

The battery modules 100a, 100b of FIG. 25 may be used as at least either of the battery modules 100a, 100b and the battery modules 100c, 100d of the battery system 500 of FIG. 28, and the battery modules 100a, 100b of FIG. 26 may be used as at least either of the battery modules 100a, 100b and the battery modules 100c, 100d of the battery system 500 of FIG. 28. In the case, the simplified configuration and reduced cost of the battery system 500 are realized. In addition, the number of the detecting circuits 20 is reduced, thereby improving processing speed of the entire battery system 500.

### (13-2)

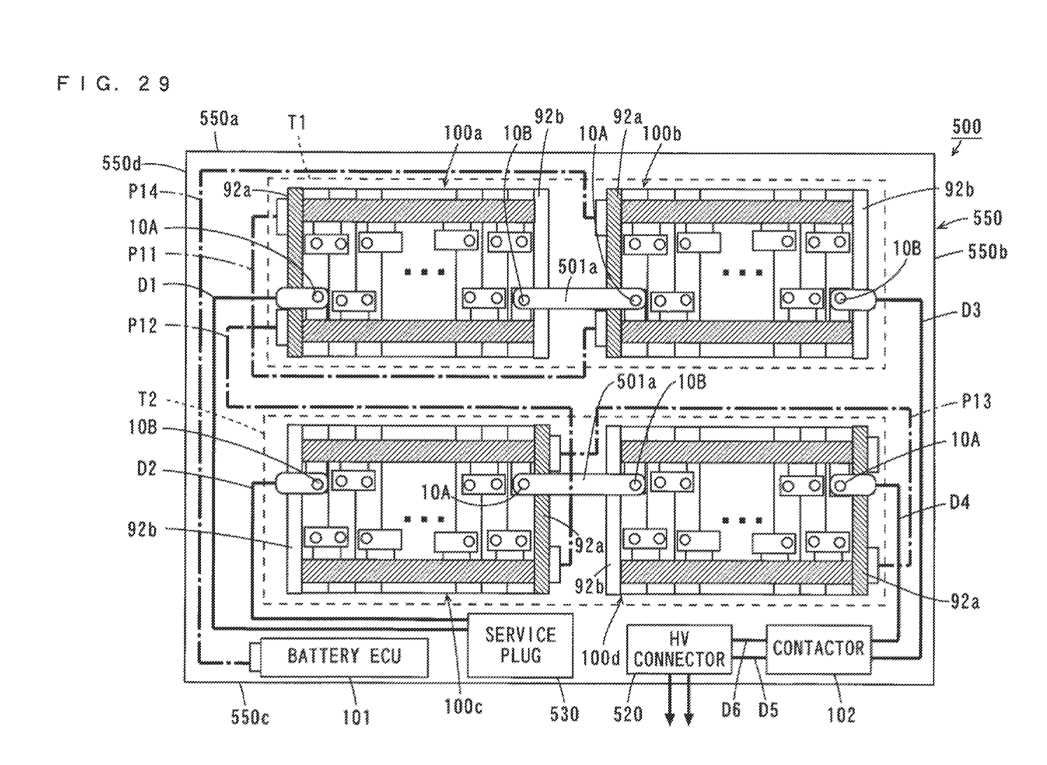

FIG. 29 is a schematic plan view showing another example of connection of communication lines in the battery system 500 of FIG. 28. Description will be made of the battery system 500 of FIG. 29 while referring to differences from the battery system 500 of FIG. 28.

The printed circuit board 21 (FIG. 2) of the battery module 100a and the printed circuit board 21 of the battery module 100b are connected to each other through a communication line P11. The printed circuit board 21 of the battery module 100a and the printed circuit board 21 of the battery module 100c are connected to each other through a communication line P12. The printed circuit board 21 of the battery module 100c and the printed circuit board 21 of the battery module 100d are connected to each other through a communication line P13. The printed circuit board 21 of the battery module 100b is connected to the battery ECU 101 through a communication line P14. The communication lines P11 to P14 constitute a bus.

The cell information detected by the detecting circuit 20 of the battery module 100a is given to the battery ECU 101 through the communication lines P11, P14. A prescribed control signal is given from the battery ECU 101 to the printed circuit board 21 of the battery module 100a through the communication lines P14, P11.

The cell information detected by the detecting circuit 20 of the battery module 100b is given to the battery ECU 101 through the communication line P14. A prescribed control signal is given from the battery ECU 101 to the printed circuit board 21 of the battery module 100b through the communication line P14.

The cell information detected by the detecting circuit 20 of the battery module 100c is given to the battery ECU 101 through the communication lines P12, P11, P14. A prescribed control signal is given from the battery ECU 101 to the printed circuit board 21 of the battery module 100c through the communication lines P14, P11, P12.

The cell information detected by the detecting circuit 20 of the battery module 100d is given to the battery ECU 101 through the communication lines P13, P12, P11, P14. A prescribed control signal is given from the battery ECU 101 to the printed circuit board 21 of the battery module 100d through the communication lines P14, P11, P12 P13.

### Second Embodiment

An electric vehicle according to a second embodiment will be described below. The electric vehicle according to the present embodiment includes the battery modules 100 and the battery system 500 according to the first embodiment. An electric automobile will be described below as an example of the electric vehicle.

### (1) Configuration

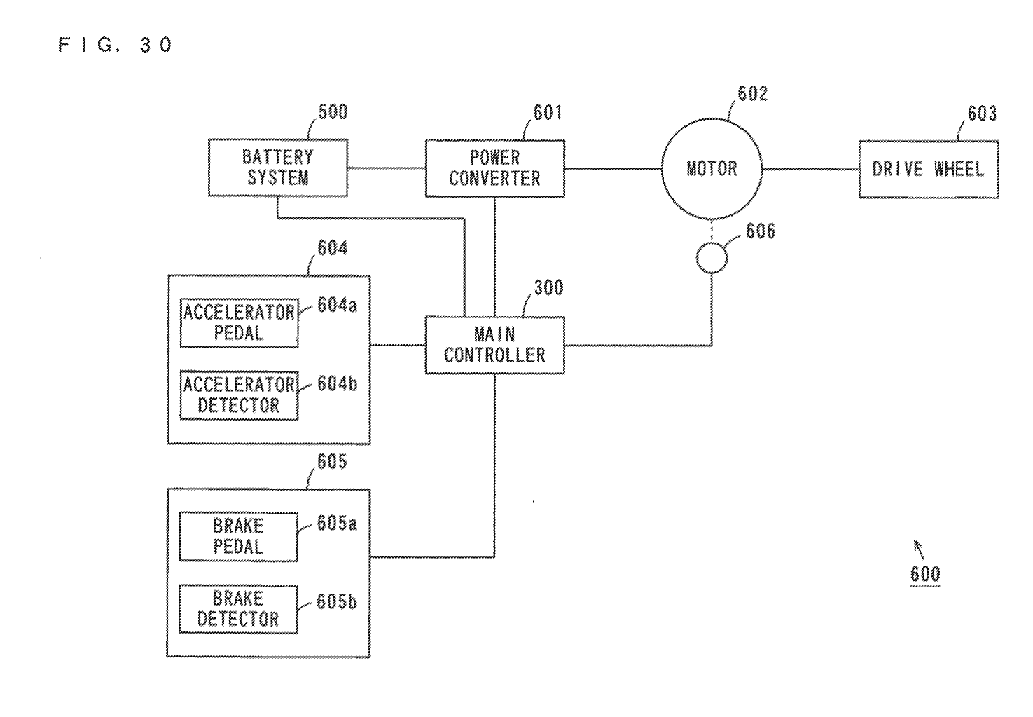

FIG. 30 is a block diagram illustrating the configuration of an electric automobile including the battery system 500 of FIG. 1, FIG. 28 or FIG. 29. As illustrated in FIG. 30, an electric automobile 600 according to the present embodiment includes the main controller 300 and the battery system 500 illustrated in FIG. 1, a power converter 601, a motor 602, a drive wheel 603, an accelerator device 604, a brake device 605, and a rotational speed sensor 606. When the motor 602 is an alternating current (AC) motor, the power converter 601 includes an inverter circuit.

In the present embodiment, the battery system 500 is connected to the motor 602 via the power converter 601 while being connected to the main controller 300. As described above, the charged capacity of each of the plurality of battery modules 100 (FIG. 1) and the value of a current flowing through the battery modules 100 are given to the main controller 300 from the battery ECU 101 (FIG. 1) composing the battery system 500. The accelerator device 604, the brake device 605, and the rotational speed sensor 606 are connected to the main controller 300. The main controller 300 includes a CPU and a memory, or a microcomputer, for example.

The accelerator device 604 includes an accelerator pedal 604a and an accelerator detector 604b for detecting an operation amount (depression amount) of the accelerator pedal 604a, which are included in the electric automobile 600. When a driver operates the accelerator pedal 604a, the accelerator detector 604b detects the operation amount of the accelerator pedal 604a on the basis of a state where the accelerator pedal is not operated by the driver. The detected operation amount of the accelerator pedal 604a is given to the main controller 300.

The brake device 605 includes a brake pedal 605a and a brake detector 605b for detecting an operation amount (depression amount) of the brake pedal 605a by the driver, which are included in the electric automobile 600. When the driver operates the brake pedal 605a, the brake detector 605b detects the operation amount. The detected operation amount of the brake pedal 605a is given to the main controller 300.

The rotational speed sensor 606 detects the rotational speed of the motor 602. The detected rotational speed is given to the main controller 300.

As described above, the charged capacity of the battery modules 100, the value of the current flowing through the battery modules 100, the operation amount of the accelerator pedal 604a, the operation amount of the brake pedal 605a, and the rotational speed of the motor 602 are given to the main controller 300. The main controller 300 carries out charge/discharge control of the battery modules 100 and power conversion control of the power converter 601 based on the information.

When the electric automobile 600 is started and accelerated based on an accelerator operation, for example, the electric power of the battery modules 100 is supplied to the power converter 601 from the battery system 500.

Furthermore, the main controller 300 calculates a torque (instruction torque) to be transmitted to the drive wheel 603 based on the given operation amount of the accelerator pedal 604a, and feeds a control signal based on the instruction torque to the power converter 601.

The power converter 601 that has received the control signal converts the electric power supplied from the battery system 500 into electric power (driving power) required to drive the drive wheel 603. Thus, the driving power obtained by the power converter 601 is supplied to the motor 602, and a torque generated by the motor 602 based on the driving power is transmitted to the drive wheel 603.

On the other hand, when the electric automobile 600 is decelerated based on a braking operation, the motor 602 functions as a power generation device. In this case, the power converter 601 converts regenerated electric power generated by the motor 602 into electric power suited to charge the battery modules 100, and applies the electric power to the battery modules 100. Thus, the battery modules 100 are charged.

### (2) Effects

The battery modules 100 according to the first embodiment are provided in the electric automobile 600 according to the second embodiment. In this case, a short is sufficiently prevented from occurring in the battery modules 100. Accordingly, the electric power supplied from the battery modules 100 to the motor 602 can be increased. This results in improved driving performance of the electric automobile 600.

### [3] Correspondences Between Constituent Elements In the Claims And Parts In Embodiments

In the following paragraph, non-limiting examples of correspondences between various elements recited in the claims below and those described above with respect to various embodiments of the present invention are explained.

In the foregoing embodiments, the X-direction is an example of one direction, the FPC boards 50, 50a to 50k, 50m are examples of an insulating substrate, the first region R11 is an example of a first region, the second region R12 is an example of a second region, and the conductor lines 51, 52, 53a are examples of a line, the conductor lines 51, 52 are examples of a voltage detection line. The FPC board 50i is an example of a first substrate, the FPC board 50j is an example of a second substrate, the FPC boards 50, 50a to 50h are examples of a common substrate, the bending line B1 is an example of a boundary line, the conductor line 52 is an example of a first line, the conductor line 53a is an example of a second line. The plus electrode 10a and the minus electrode 10b are an example of a pair of electrode terminals, the gas vent valve 10v is an example of a gas discharge portion, the contactor 102 is an example of a connection switcher, the battery ECU 101 is an example of a controller, and the electric automobile 600 is an example of an electric vehicle.

As each of various elements recited in the claims, various other elements having configurations or functions described in the claims can also be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/we claim:

1. A battery module comprising:
a plurality of battery cells;
an insulating substrate having first and second regions arranged along said plurality of battery cells; and
a plurality of lines formed in said insulating substrate, wherein
said plurality of lines include a plurality of voltage detection lines electrically connected to said plurality of battery cells, respectively, for detecting terminal voltages of said plurality of battery cells, and
said first and second regions of said insulating substrate are arranged on different planes.

2. The battery module according to claim 1, wherein
said plurality of battery cells are arranged to line up in one direction,
said insulating substrate includes a common substrate having said first region and said second region with a boundary line extending in said one direction interposed between said first region and said second region, and
said common substrate is bent along said boundary line.

3. The battery module according to claim 2, wherein
one side portion of said first region extends in said one direction along said plurality of battery cells,
said plurality of voltage detection lines are provided to extend from said one side portion of said first region to one end portion of said common substrate, and
said second region has a smaller length in said one direction than said first region, and arranged on a side of said one end portion of said common substrate so as to be along said first region.

4. The battery module according to claim 2, wherein
said plurality of lines include:
a plurality of first lines that extend parallel to one another along said boundary line in said first region; and
a plurality of second lines that extend parallel to one another along said boundary line in said second region, and
a distance between a first line that is the closest to said boundary line among said plurality of first lines and a second line that is the closest to said boundary line among said plurality of second lines is larger than a distance between said plurality of first lines, and is larger than a distance between said plurality of second lines.

5. The battery module according to claim 2, wherein
each of said plurality of battery cells has a pair of electrode terminals that line up in a direction intersecting with said one direction, and includes in a portion between said pair of electrode terminals a gas discharge portion for discharging gas in the battery cell when internal pressure of the battery cell rises,
said insulating substrate is arranged to pass through at least one of a portion between said gas discharge portion and one electrode terminal of each battery cell and a portion between said gas discharge portion and the other electrode terminal of each battery cell, and
each voltage detection line is connected to the one electrode terminal or the other electrode terminal of each battery cell.

6. The battery module according to claim 1, wherein
said insulating substrate includes a first substrate having said first region and a second substrate having said second region, and
said first substrate and said second substrate are arranged to overlap each other.

7. A battery system comprising:
a plurality of battery modules each including a plurality of battery cells;
a voltage detector that is used in common for said plurality of battery modules and detects terminal voltages of said battery cells;
an insulating substrate provided along said plurality of battery cells of said plurality of battery modules and connected to said voltage detector; and
a plurality of voltage detection lines formed in said insulating substrate, and electrically connected to said plurality of battery cells, respectively, of said plurality of battery modules and to said voltage detector for detecting the terminal voltages of said plurality of battery cells of said plurality of battery modules, wherein
said insulating substrate includes:
a first region extending along said plurality of battery cells of said plurality of battery modules; and
a second region extending along at least part of said plurality of battery cells of said plurality of battery modules; and
said first and second regions of said insulating substrate are arranged on different planes.

8. An electric vehicle comprising:
the battery module according to claim 1;
a motor driven by electric power supplied from said battery module; and
a drive wheel rotated by a torque generated by said motor.

9. An electric vehicle comprising:
the battery system according to claim 7;
a motor driven by electric power supplied from said plurality of battery modules of said battery system; and
a drive wheel rotated by a torque generated by said motor.
